(19) United States
(12) Patent Application Publication
(10) Pub. No.: US 2008/0281942 A1
(43) Pub. Date: Nov. 13, 2008

(54) Data Processing Device

(76) Inventors: Tohru Nakahara, Osaka (JP); Akio Higashi, Osaka (JP); Ryuichi Okamoto, Osaka (JP); Mitsuhiro Inoue, Osaka (JP); Natsume Matsuzaki, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/631,007

(22) PCT Filed: Jun. 21, 2005
(86) PCT No.: PCT/JP05/11304

§ 371 Date: Dec. 28, 2006

(30) Foreign Application Priority Data
Jun. 28, 2004 (JP) 2004-189061

(51) Int. Cl. G06F 15/173

(52) U.S. Cl. 709/218

(57) ABSTRACT

The present invention makes it possible to use data that is held by a given terminal device in another terminal device, even after the given terminal device can no longer be accessed externally. If a terminal device 100a detects an event wherein one's own terminal will no longer be externally accessible, then the data held by one's own terminal 100a is transferred to another device 200 that can be accessed externally. Another terminal device 100b, which acquires and uses data, acquires data from the device 200, and uses such.

### FIELD OF THE INVENTION

The present invention relates to a data processing device in a system that is capable of moving data among a plurality of data processing devices.

### RELATED ART

In recent years, an increasing number of content distribution services have started up that distribute added value data (hereinbelow, denoted as data), such as digital content (e.g., music, videos and games) and the rights to use that content, to data processing devices via networks, such as the Internet, as well as via digital broadcasting and packaged media.

Users want to use the data acquired from content distribution services on data processing devices that are convenient to them. On the other hand, there are cases wherein acquired data is used simultaneously on a plurality of data processing devices, or is even reproduced without permission, which cause problems from the perspective of copyright protection. Consequently, there is a need for a data moving device that moves data among a plurality of data processing devices without reproducing it. With conventional data moving devices, movement is implemented by the following method.

A data utilization device that is seeking to use data issues a data acquisition request to a data holding device, which holds data. Upon receiving that acquisition request, the data holding device transfers data that is stored on a storage medium, such as an HDD, to the data utilization device that is the source of the request, i.e., the request-source data utilization device. When the transfer process is complete, the data holding device deletes the data from the storage medium.

Nonetheless, if, for example, the user loses the data holding device or the electric power source of the data holding device is cut, then that data holding device cannot be accessed externally. Consequently, the data utilization device cannot acquire the data. As a result, a situation arises wherein the data cannot be used on any data utilization device.

Accordingly, from a user data protection perspective, there is a need for a mechanism wherein a data utilization device can use the data held by the data holding device, even if the data holding device cannot be externally accessed. For example, Patent Document 1 discloses a technology that makes it possible for a user to use data in a data holding device and a data utilization device by setting a data utilization interval for each device and coordinating the data utilization intervals so that they do not overlap. With this mechanism, it is possible to prevent the simultaneous usage of data on a plurality of devices, while at the same time enabling a data utilization device to use data, which is held by a data holding device that has become externally inaccessible, for a fixed utilization time.

However, with the technology recited in Patent Document 1, if a certain device T1 wants to use data during a time period P2 that is outside of the usable time period P1 permitted to the device T1, then the device T1 needs to acquire the usable time period P2, which includes the time of desired usage, by communicating with another device T2 that is permitted to use the data in the usable time period P2. However, if that other device T2 cannot be accessed externally, then the device T1 cannot acquire the usable time period P2. In other words, if for some reason, e.g., electric power is off, a certain device cannot be externally accessed during the time period when that device is permitted to use the data, then the data cannot be used by that device or by any device, which is problematic.

It is an object of the present invention to provide a technology that allows data that is held by a device to be used by another device, even after the data holding device can no longer be externally accessed.

It is another object of the present invention to improve user friendliness by performing a communication process in line with the user's intention, with a timing intended by the user.

### Patent Document 1

Japanese Published Unexamined Patent Application No. 2002-73045

### DISCLOSURE OF THE INVENTION

To solve the abovementioned problems, a first aspect of the invention provides a data processing device that comprises the following means:
an event detecting means that detects a prescribed event;
a control information storing means that stores control information, the control information including a communication process rule wherein one or a combination of two or more events is prescribed;
a communication process controlling means that, based on an event detected by the event detecting means, determines whether the communication process rule in the control information is satisfied; and
a communicating means that performs the communication process on the data if the communication process controlling means determines that the communication process rule is satisfied.

Examples of prescribed events include the departure and return of a data processing device (hereinbelow called a vehicle onboard terminal), which is installed in a vehicle, from and to a domain, and the entrance and exit of a vehicle to and from a garage. The turning off of the electric power source is included in the departure from the domain. The turning on of the electric power source is included in the return to the domain. Examples of the communication process include the data transfer process and the data acquisition process. The communication process rule can be described by one or the combination of two or more events. An exemplary communication process rule is “vehicle is in the garage and the power source of the onboard data processing device is turned off.” Another communication process rule example is “vehicle has exited the garage and is leaving the domain.” Here, a domain is one that groups terminals that can share data and move data among them.

A second aspect of the invention provides a data processing device according to the first aspect, wherein the control information storing means associates and stores the communication process rule with a communication enabled/disabled determination rule for determining whether to execute the communication process. In this device, if it is determined that the communication process rule is satisfied, then the communication process controlling means further determines whether to execute the communication process based on the communication enabled/disabled determination rule. In addition, if the communication process controlling means determines that the communication process is to be executed, then the communicating means performs the communication process on the data.

For example, in the case of the rule “vehicle has exited the garage and is leaving the domain,” the onboard device performs the acquisition after determining whether to execute data acquisition. Thereby, even with the same communication process rule, the transfer and acquisition of data is performed without performing processes in inappropriate cases, which makes it possible to perform the data processing flexibly. Examples of communication enabled/disabled determination rule include “transfer is enabled only to terminal of user who owns the data” and “taking outside the domain is disabled if the utilization frequency is high.”

A third aspect of the invention provides a data processing device according to the first aspect, wherein the communication process is data transfer. This device further comprises a data storing means that stores data that is a potential transfer target. In this device, if the communication process controlling means determines that the communication process rule is satisfied, then the communicating means reads the transfer target data from the data storing means, and transfers the read data to a transfer destination.

When, for example, the electric power source is turned off, the data processing device transfers a transfer target file “DATA 1” to another data processing device “T1.” Consequently, after this data processing device has turned off, a separate data processing device that needs the data file “DATA1” can acquire the data file “DATA1” from the transfer destination data processing device “T1” and use the data file.

A fourth aspect of the invention provides a data processing device according to the first aspect, wherein the communication process is data acquisition. In this device, if the communication process controlling means determines that the communication process rule is satisfied, then the communicating means acquires the acquisition target data from an acquisition destination that stores that data.

The convenience of the user can be improved. For example, when an onboard data processing device of a vehicle in a garage has turned on, the user can enjoy new music in the vehicle by acquiring new music files from a home server.

A fifth aspect of the invention provides a data processing device according to the third or the fourth aspects, wherein the control information storing means associates and stores the communication rule with a communication destination condition which specifies a communication destination with which the communication process is performed. In this device, the communicating means determines the transfer destination or the acquisition source based on the communication process rule associated with the communication destination condition.

Based on the above constitution, the data processing device can specify which communication process rule to use and with which communication destination to communicate. The communication destination condition is for specifying the data transfer destination and the data acquisition destination. An identifier that identifies another data processing device, e.g., a MAC (Media Access Control) address or a network address; a port number; as well as all terminals connected to the network can be described as communication destination conditions.

A sixth aspect of the invention provides a data processing device according to the third or the fourth aspects, wherein the control information storing means associates and stores the communication process rule with a communication process target condition which specifies data that is subject to the communication process. In this device, the communicating means performs the communication process on the data specified by the communication process rule associated with the communication process target condition.

Based on the above constitution, the data processing device can specify which data to process by which communication process rule. The communication process target condition is for specifying the data that is subject to the communication process. For example, information that specifies a file, attribute information of the file itself, attribute information of the file contents, and attribute information specified by the user are used as communication process target conditions. Examples of information that specify a file include a file name and an extension. An example of attribute information of the file itself is the file size. Examples of attribute information of the file contents include the type and length of the contents. An example of attribute information specified by the user is the priority level.

A seventh aspect of the invention provides a data processing device according to the third or the fourth aspects, wherein the control information storing means associates and stores a control information identifier, which identifies the control information, with a data identifier, which identifies data that is subject to the communication process.

Associating the control information identifier with the data identifier makes it possible to store the communication process target data independently of the control information. Thereby, it is possible to manage the communication process rule of the data file, the communication destination, and the like on a data processing device unit basis. For example, a data processing device can apply a common communication process rule, communication destination and the like to a plurality of data files. More specifically, let us assume that the communication process rule for acquiring the data is “when the power source turns on,” that the communication destination is “home server,” and that the communication process target condition is “music file.” In this case, when the electric power source is turned on, all music files in the home server are downloaded to the data processing device.

An eighth aspect of the invention provides a data processing device according to the third or the fourth aspects, wherein the control information storing means integrally stores the data, which is subject to the communication process, and the control information.

The communication process rule, the communication destination, and the like can be managed on a communication target data unit basis, without depending on the data processing device. In other words, it is possible to always maintain a fixed communication process rule and corresponding communication destination, which are applied to a data file, even if the data processing device changes. For example, let us assume that the communication process rule of the transfer process is “when the power source turns off,” that the communication destination is “home server,” and that the communication process target condition is a file named “DATA1.” In this case, even if the data file “DATA1” exists in some data processing device, that data file “DATA1” is transferred to the home server every time the data processing device is turned off.

A ninth aspect of the invention provides a data processing device according to the third or the fourth aspects, wherein the control information storing means associates the communication process rule with a postprocess which is executed after the communication process. In this device, the communicating means executes the postprocess after the communication process.

For example, if “delete transferred data file” is set in advance as the postprocess, then that data can be deleted after the transfer. If the data file is protected by copyright, then it is preferable because the data needs to be deleted after the transfer.

A tenth aspect of the invention provides a data processing device according to the third or the fourth aspects, wherein the control information storing means associates and stores the communication process rule with a notification process rule which specifies a notification process that notifies a user. This device further comprises a notification process controlling means that, based on an event detected by the event detecting means and the communication process rule in the control information, determines whether or not there is a need to perform the notification process with respect to the user. In addition, this device further comprises a notification processing means that, if the notification process controlling means determines that there is a need to perform the notification process, executes the notification process with respect to the user specified by the notification process rule prior to executing the communication process.

Examples of notification processes include the display of a message, the output of audio, the vibration of a prescribed output device, and the output of a smell from an olfactory output device. Notifying the user of the transfer or acquisition of data prior to executing the communication process makes it possible to prevent the execution of a communication process that was not intended by the user.

An eleventh aspect of the invention provides a data processing device according to the third or the fourth aspects, further comprising a control information receiving means that receives the registration of control information user by user. In this device, the control information storing means stores the control information on a user basis.

Setting the control information on a user basis makes it possible to perform the transfer process and the acquisition process finely tuned to the preferences of the user. In addition to the details of the control information itself, the setting of whether to manage the control information on a data transfer device basis or on a data unit basis may also be received on a user basis.

A twelfth aspect of the invention provides a data processing device according to the third or the fourth aspects, further comprising a communication process log storing means that stores a processing log of the communication processes performed by the communicating means.

For example, if a transfer log of the data file is stored in advance, it is possible to easily specify, based on the transfer log, the location from which to reacquire the data file that was unfortunately transferred. In addition, if a postprocess that deletes the data file after the transfer is set, then the transfer completed data file is deleted after the data file for which the transfer is completed is registered in the transfer log, which can prevent misoperation, such as the unfortunate deletion of a data file prior to the completion of the transfer.

A thirteenth aspect of the invention provides a data processing device according to the third or the fourth aspects, further comprising an electric power storage control unit that calculates the amount of electric power needed to execute the data communication process, and controls the storage of needed electric power.

By storing the electric power needed to transfer or acquire data, the prescribed communication process can be executed even if the electric power source of the data processing device is turned off.

A fourteenth aspect of the invention provides a data processing method, comprising the following steps:
an event detecting step that detects a prescribed event;
a control information storing step that stores control information that includes a communication process rule, wherein one or a combination of two or more events are prescribed;
a communication process controlling step that, based on an event detected by the event detecting step, determines whether or not the communication process rule in the control information is satisfied; and
a communicating step that performs the communication process with respect to the data if the communication process controlling step determines that the communication process rule is satisfied.

With this method, the same operational effects are obtained as with the data processing device of the first invention.

A fifteenth aspect of the invention provides a data processing program that is executed by a computer. This program causes the computer to function as the following means:
an event detecting means that detects a prescribed event;
a control information storing means that stores control information that includes a communication process rule, wherein one or a combination of two or more events is prescribed;
a communication process controlling means that, based on an event detected by the event detecting means, determines whether or not the communication process rule in the control information is satisfied; and
   a communicating means that performs the communication process with respect to the data if the communication process controlling means determines that the communication process rule is satisfied.

This program obtains the same operational effects as with the data processing device of the first invention.

Based on the present constitution, even after the data processing device can no longer be externally accessed, data that was held by that data processing device can be used by another data processing device. In addition, automatically processing data in accordance with a detection event set by the user improves the convenience of the user.

In addition, by sensorily notifying the user of the processing of the data, gaining the user's consent and then starting the process, it is possible to improve the convenience of the user while preventing automatic processing that goes against the user's intention.

### BRIEF DESCRIPTION OF THE DRAWINGS

FIG. 1 is an explanatory diagram that depicts the constitution of a data processing system S, which includes data processing devices of the present invention.

FIG. 2 is a functional block diagram that depicts the functional constitution of a terminal device.

FIG. 3 is a functional block diagram that depicts the detailed constitution of a server.

FIG. 4 is a conceptual explanatory diagram of the information that is stored in a data storage unit of the terminal device and the server.

FIG. 5 is a conceptual explanatory diagram of the information that is stored in a control information storage unit of the terminal device.

FIG. 6 is a conceptual explanatory diagram of the information that is stored in a transfer log storage unit of the terminal device.

FIG. 7 is a conceptual explanatory diagram of the structure of the control information for controlling the data communication process.

FIG. 8 is one example of a control information input screen (menu screen) that is output by a control information generation unit.

FIG. 9 is one example of a control information input screen (transfer settings) that is output by the control information generation unit.

FIG. 10 is one example of a control information input screen (acquisition settings) that is output by the control information generation unit.

FIG. 11 is a flow chart that depicts one example of the flow of the preparatory process for control information generation and detection executed by the terminal device.

FIG. 12 is a flow chart that depicts one example of the flow of a data transfer process that is executed by the data processing system S.

FIG. 13 is a flow chart that depicts one example of the flow of a data acquisition process that is executed by the data processing system S.

FIG. 14(a) is an explanatory diagram that depicts a state wherein a terminal device 100b has left a domain, and FIG. 14(b) is an explanatory diagram that depicts a state wherein the terminal device 100b has returned to the domain.

FIG. 15 is an explanatory diagram that depicts one example of a communication enabled/disabled determination rule.

FIG. 16 is an explanatory diagram that depicts one example of an inquiry screen from a terminal device that is trying to acquire data α.

FIG. 17 is an example of a screen that depicts the collected responses.

FIG. 18 is a conceptual explanatory diagram that depicts the structure of control information according to a second embodiment.

FIG. 19 is a flow chart that shows one example of the flow of the process performed by the terminal device in the second embodiment.

FIG. 20 is a functional block diagram of a terminal device according to a third embodiment.

FIG. 21 is a conceptual explanatory diagram that depicts the structure of control information C200 according to the third embodiment.

FIG. 22 is an example of a screen that accepts a user's input for generating control information C200.

FIG. 23 is a flow chart that shows the flow of a sensory notification process executed by the terminal device according to the third embodiment.

FIG. 24 is an example of a screen that shows one example of visual sensory notification output that is output when the communication process rule is satisfied.

### DETAILED DESCRIPTION OF THE PREFERRED EMBODIMENTS

### Summary of the Invention

### (1) Overview of a System Wherein the Present Invention is Adapted

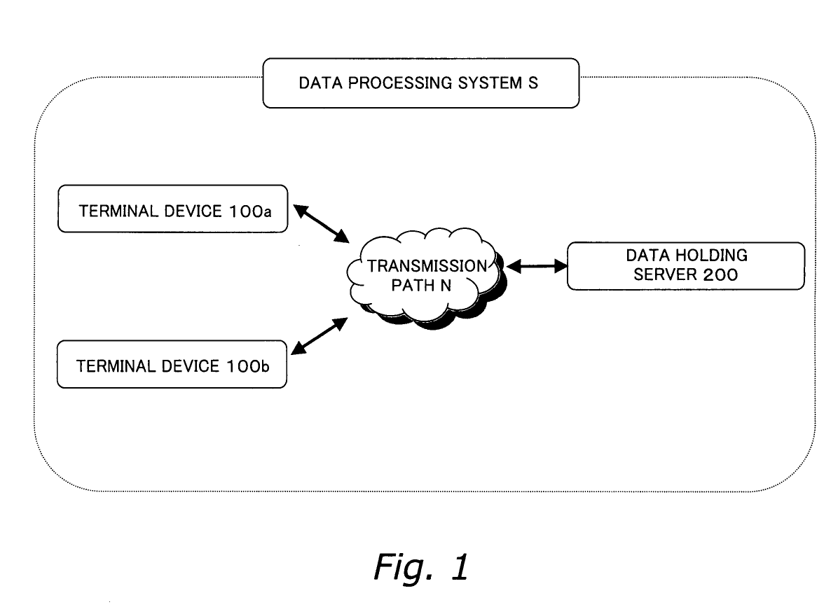

FIG. 1 is an explanatory diagram that shows the constitution of a data processing system S, which includes data processing devices of the present invention. The data processing system S comprises one or more terminal devices 100a, 100b (correspond to data processing devices in the claims), and a data holding server 200 (hereinbelow, referred to simply as a server). A transmission path N, such as a LAN, connects a plurality of terminal devices 100 and the server 200, and data can be sent and received therebetween.

Each of the terminal devices 100 is a data replay device, a recording device, or a combination device that holds and uses data. Specific examples of a terminal device 100 include an STB (set-top box) for receiving digital broadcasting, a digital TV, a DVD (Digital Versatile Disc) recorder, an HDD (hard disk drive) recorder, a PC (personal computer), a PDA (personal digital assistant), or a mobile phone.

The server 200 stores the data received from the terminal devices 100, and provides the data thereto. Specifically, the server 200 comprises a storage medium, such as an HDD, and has excellent crash resistance that is achieved by means of, for example, data backup by tape and the use of RAID (redundant arrays of inexpensive disks).

The transmission path N specifically comprises a network, e.g., a wired network such as an Ethernet, a wireless network such as a wireless LAN, or a network that combines such. Furthermore, if data, such as copyright protected data, that requires confidential management along the communication path is sent and received between devices via the transmission path N, then it is preferable to send and receive such data after establishing a secure authenticated channel (hereinbelow denoted as an SAC). To establish an SAC, it is possible to use, for example, SSL (secure socket layer) or TLS (transport layer security).

### (2) Specific Example

The present invention will now be explained by setting forth an example. Let's assume that a user A has a vehicle onboard terminal ACT, which is installed in an automobile, and a DVD recorder AD, which is installed in a living room, and that both serve as terminal devices 100. Furthermore, the user A owns a home server HS, which serves as the server 200. Furthermore, each of the devices is mutually connected by the network.

Step S1: The user A pays consideration to acquire a movie, “The Matrix,” which is copyright protected data, and records such on the DVD recorder AD.

Step S2: When the user A leaves home in his or her vehicle, the user A downloads the movie, “The Matrix,” to the vehicle onboard terminal ACT via the network.

Step S3: When the user A returns home, he or she turns off the engine of the automobile and thus simultaneously turns off the electric power source of the vehicle onboard terminal ACT. At this time, the movie, “The Matrix,” is transferred to the home server HS based on belowmentioned control information C1, which is set by the user A. The control information C1 includes: (1) a transfer rule, (2) a transfer target condition, and (3) a transfer destination condition, which serve as the transfer conditions. These values are as follows.

Control Information C1
Transfer rule: When the electric power source of the vehicle onboard terminal ACT turns off
Transfer target condition: Movie, “The Matrix”
Transfer destination condition: Home server HS

Step S4: The user A tries to play “The Matrix” on the home DVD recorder AD. Because the movie, “The Matrix,” does not exist on the DVD recorder AD, the DVD recorder AD accesses the home server HS based on control information C2 and reacquires the movie, “The Matrix.” The control information C2 includes: (1) an acquisition rule, (2) an acquisition target condition, and (3) an acquisition destination condition, which all serve as acquisition conditions. These values are as follows.

Control Information C2
Acquisition rule: When there is a playback instruction and the data to be played back does not exist
Acquisition target condition: All movies
Acquisition destination condition: Home server HS.

Thus, by transferring or acquiring the movie, “The Matrix,” based on control information, the user A can enjoy the movie at any time on a terminal device 100 that is convenient to him or her.

### First Embodiment

[Functional Constitution]

The following is a detailed explanation of the functional constitution of the terminal devices 100 and the server 200, which constitute the data processing system S, referencing the drawings. Furthermore, in the explanation below, a data identifier is information that uniquely specifies data in the data processing system S, e.g., a file name or a URL. A user identifier is information that uniquely specifies a user in the data processing system S. A device identifier is information that uniquely specifies one of the terminal devices 100 or the server 200 in the data processing system S, e.g., a MAC address or an IP address. The device identifier of each device is stored in its own nonvolatile memory. In the present embodiment, the device identifiers of the terminal devices 100a, 100b and the server 200 are as follows.

Terminal device 100a: TERMINAL-ID-000A

Terminal device 100b: TERMINAL-ID-000B

Server 200: HOME-SERVER-0001

### (1) Functional Constitution of a Terminal Device

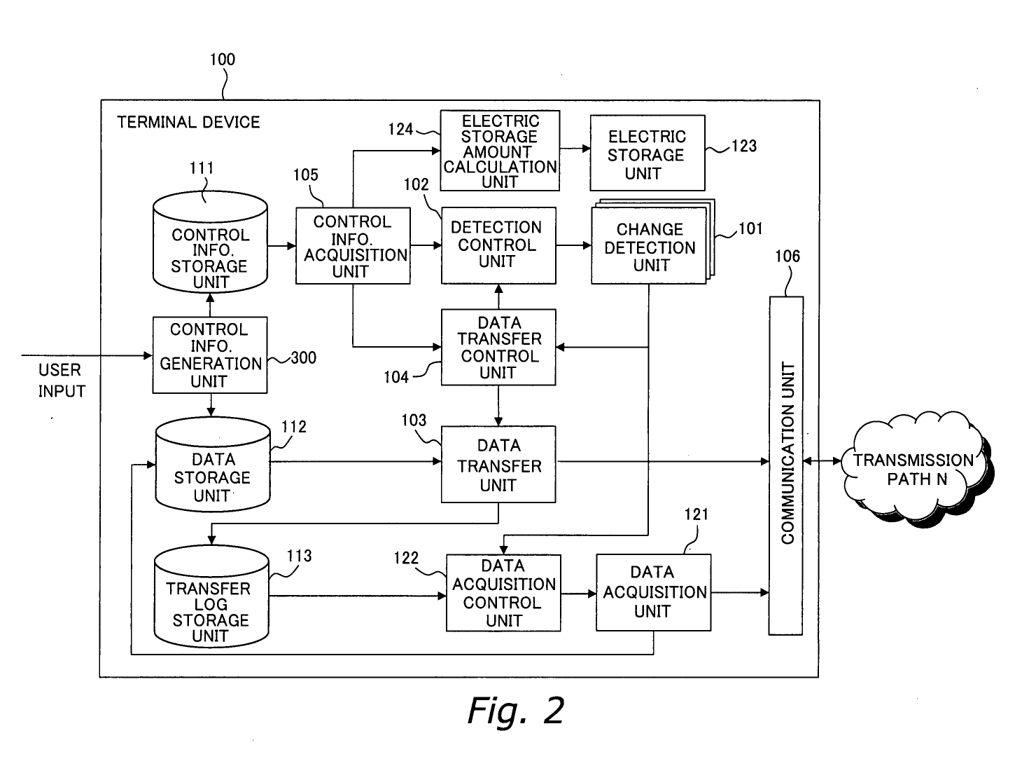

FIG. 2 is a functional block diagram that shows the functional constitution of a terminal device 100. The terminal device 100 comprises the constituent elements (a)-(n) listed below. The terminal device 100 is a data processing device that comprises: a storage medium, such as an HDD; a CPU; RAM; and ROM. In (a)-(c) below, the storage unit is implemented by the storage medium, and in (d)-(n), the processing unit is implemented by a program executed by the CPU. Furthermore, data stored on the storage medium can be acquired by, for example, downloading it from a separate device.
(a) Control information storage unit 111: This unit stores the control information.
(b) Data storage unit 112: This unit stores data.
(c) Transfer log storage unit 113: This unit stores the data transfer log.
(d) Change detection unit 101: This unit connects to one or more detection devices, such as a sensor, and detects a predetermined event.
(e) Detection control unit 102: This unit controls the change detection unit 101 based on the abovementioned control information.
(f) Data transfer unit 103: This unit transfers the data.
(g) Data transfer control unit 104: This unit controls the data transfer unit 103 based on control information.
(h) Control information acquisition unit 105: This unit reads control information from the control information storage unit 111 or the data storage unit 112.
(i) Communication unit 106: This unit communicates with the server 200 or another terminal device 100.
(j) Data acquisition unit 121: This unit acquires data from the server 200 or another terminal device 100.
(k) Data acquisition control unit 122: This unit controls the data acquisition unit 121 based on the transfer log.
(l) Electric storage unit 123: This unit stores electric power for transferring or acquiring data.
(m) Electric storage amount calculation unit 124: This unit calculates the electric energy to be stored by the electric storage unit 123.
(n) Control information generation unit 300: This unit receives user input, generates control information based on the user input, stores control information in the control information storage unit 111, or attaches control information to the data of the data storage unit 112.

### (2) Functional Constitution of the Server

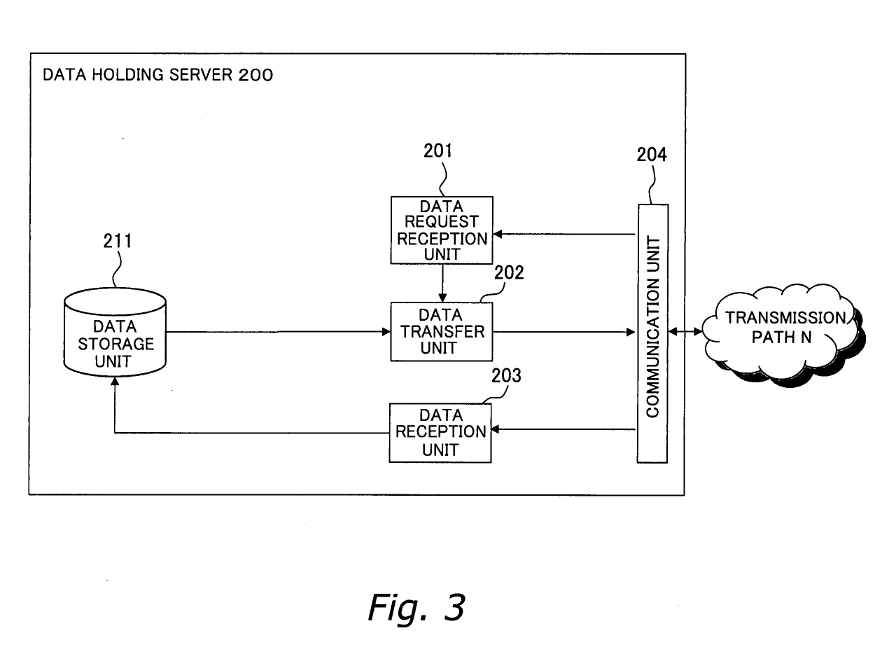

FIG. 3 is a functional block diagram that shows the detailed constitution of the server 200. The server 200 has the constituent elements (a)-(e) listed below. The server 200 is a data processing device that has, for example: a storage medium, such as an HDD; a CPU; RAM; and ROM. In (a), the storage unit is implemented by a storage medium, and in (b)-(e), each processing unit is implemented by a program, which is executed by the CPU.
(a) Data storage unit 211: This unit stores data.
(b) Data request reception unit 201: This unit receives a data acquisition request from the terminal device 100.
(c) Data transfer unit 202: This unit transfers data held by the data storage unit 211 in accordance with the data acquisition request.
(d) Data reception unit 203: This unit receives data from the terminal device 100 and stores such in the data storage unit 211.
(e) Communication unit 204: This unit communicates with another terminal device 100.

### [Information Stored by the Data Processing System]

The following explains the information stored by the data storage units 112, 211, the control information storage unit 111, and the transfer log storage unit 113. The control information will also be explained in detail.

### (1) Data Storage Units

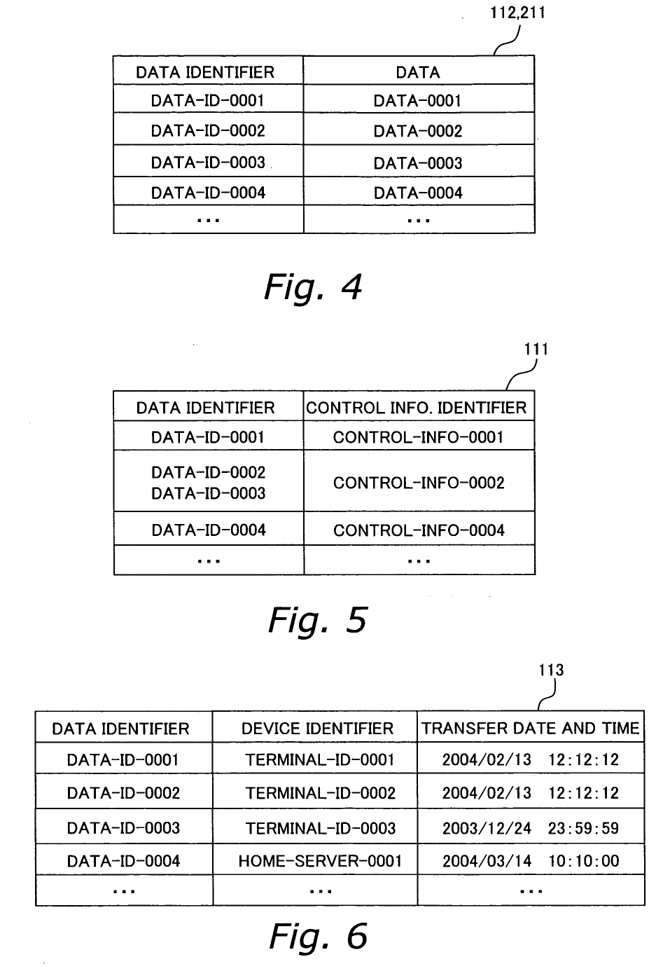

FIG. 4 is a conceptual explanatory diagram of information stored by the data storage unit 112 of the terminal device 100 and the data storage unit 211 of the server 200. The data storage units 112, 211 associates and stores the data identifiers and data. FIG. 4 shows an example of a data identifier “DATA-ID-0001” associated with the data “DATA-0001.” Data is the object of the communication process, such as transfer or acquisition. There are cases wherein the control information is appended to the data, as discussed later.

Data will now be explained by setting forth a specific example. Data generated by a provider includes, for example: “provider content,” such as music, videos, and games; “license information,” which gives the right to use the provider content; “module (program) that implements the function of a computer terminal”; and “encryption key,” which is used, for example, for authentication between devices. In addition, data generated by an individual user includes: a “personal schedule”; “settings file of the computer terminal”; and “personal content,” such as family photos from a digital camera. Generally, the former are protected by, for example, copyrights, and reproduction is restricted. The latter is personal data, and reproduction is consequently not restricted. Furthermore, in the case of the latter, reproduction of, for example, family photos may also be restricted in consideration of privacy protection.

To register data in the data storage unit 112 of the terminal device 100, the terminal device 100 links data with its data identifier and stores such in the data storage units 112, 211 when acquiring data externally through, for example, the Internet, digital broadcasting, or packaged media.

The registration of data in the data storage unit 211 of the server 200 is achieved by, for example, a server transfer from the terminal device 100 to the server 200.

### (2) Control Information Storage Unit

FIG. 5 is a conceptual explanatory diagram of information that is stored in the control information storage unit 111 of the terminal device 100. Data identifiers and control information identifiers are associated and stored in the control information storage unit 111. Each control information identifier specifies control information. Thereby, data and control information, which is stored independently of the data, are linked, and control information can be managed on an individual terminal device 100 basis. In addition, control information is stored in the control information storage unit 111. Control information is controls communication processes, such as data transfer and acquisition. Control information will be discussed later in detail.

FIG. 5 shows that, for example, the control information of the control information identifier “CONTROL-INFO-0001” corresponds to the data of the data identifier “DATA-ID-0001.” In addition, the control information of the control information identifier “CONTROL-INFO-0002” corresponds to the data of the data identifier “DATA-ID-0002” as well as the data of the data identifier “DATA-ID-0003.”

The generation of control information registers that information in the control information storage unit 111.

### (3) Transfer Log Storage Unit

FIG. 6 is a conceptual explanatory diagram of the information stored in the transfer log storage unit 113 of the terminal device 100. Data identifiers, device identifiers, and transfer dates and times are associated and stored in the transfer log storage unit 113. For example, when an attempt is made to reacquire transferred data, the acquisition destination can be easily specified by referencing the transfer log. For example, FIG. 6 shows that the data of the data identifier “DATA-ID-0001” was transferred to the terminal device 100 that corresponds to the device identifier “TERMINAL-ID-0001” on Feb. 13, 2004 at 12:12:12.

Data is registered in the transfer log storage unit 113 by the terminal device 100 executing a transfer process that transfers the data to the server 200 or another terminal device 100.

Furthermore, in the present embodiment, the transfer log is stored as a communication process log, but a log of the acquired data may be similarly stored in advance and referenced when the data is retransferred or reacquired.

### (4) Control Information

### (4-1) Overview of the Structure of Control Information

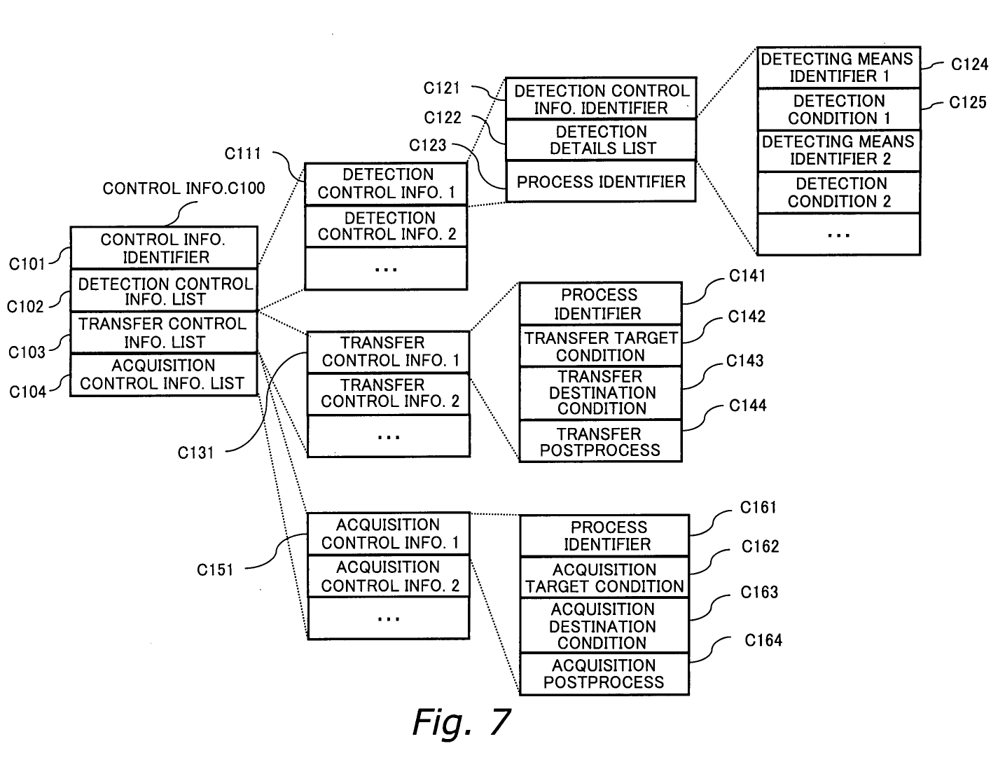

FIG. 7 is a conceptual explanatory diagram of the structure of control information that controls a data communication process. Control information is stored in the data storage unit 112 along with data, or in the control information storage unit 111 independent of data.

The control information includes a communication process rule, a communication process target condition, and a communication destination condition. The communication process rule is a condition for determining whether to execute the data communication process. The communication process target condition is for specifying data that is subject to the communication process when the communication process rule is satisfied. The communication destination condition is for specifying the other party with which the data communication process is performed.

In the present embodiment, it is assumed that the communication process includes two aspects: data transfer and data acquisition; in addition, the communication process rule is shared by the transfer process and the acquisition process. Namely, the transfer target condition and the transfer destination condition, as well as the acquisition target condition and the acquisition destination condition are associated with the same communication process rule. Of course, the association of the communication process rule with the communication target condition and the communication destination condition may be determined according to the communication process type. In addition, the data processing system S may not necessarily perform more than one type of communication process.

### (4-2) Specific Example of the Entire Structure

Referencing FIG. 7 once again, a specific example of the data structure of control information will now be explained. In the present embodiment, control information C100 has a hierarchical structure. The first level of the control information C100 includes the following information items (a)-(d).
(a) Control information identifier C101: This identifier uniquely specifies the control information C100.
(b) Detection control information list C102: This list includes a description of the communication process rule, which is the trigger for executing the communication process. Namely, it describes a condition for starting the communication process with respect to the data linked with the control information C100. Specifically, it describes a transfer rule or an acquisition rule, which both define one or a combination of two or more events detected by the change detection unit 101 of the terminal device 100.
(c) Transfer control information list C103: This list sets the control details of the data transfer process. It includes at least a transfer destination condition, and preferably includes a description of the transfer target condition and a transfer postprocess.
(d) Acquisition control information list C104: This list sets the control details of the data acquisition process. It includes at least the acquisition target condition and the acquisition destination condition, and preferably includes a description of the acquisition postprocess.

### (4-3) Detection Control Information

The detection control information list C102 includes one or more detection control information C111 entries. Each detection control information C111 entry includes the following information items (b1)-(b3).
(b1) Detection control information identifier C121: This identifier uniquely specifies a detection control information C111 entry.
(b2) Detection details list C122: This list describes one or a combination of two or more events that are detectable by the change detection unit 101 of the terminal device 100.
(b3) Process identifier C123: This identifier describes a pointer to the processing details in the control information C100 that are executed if the detection details list C122 is satisfied. In the present example, the process identifier C123 describes a pointer to transfer control information C131 or acquisition control information C151, which are discussed later.

The abovementioned detection details list C122 will now be explained in greater detail. The detection details list C122 includes one or more pairs of a detecting means identifier C124 and a detection condition C125. Each detecting means identifier C124 uniquely specifies a sensor that detects an event. Each detection condition C125 describes one event. The event described by the detection condition C125 is detected by the sensor specified by the paired detecting means identifier C124. One or a combination of two or more detection conditions C125, i.e., one or a combination of two or more events, included in the detection details list C122 constitutes a communication process rule for determining whether to execute the communication process. The following describes specific examples of events to be detected.

Example 1: A Sensor that Detects a Cutoff of the Electric Power Supply is Connected to the Terminal Device 100
“Detecting means identifier C124: electric power source state detecting means; detection condition C125: electric power source off”
   Example 2: A Sensor that Detects a Cutoff of the Electric Power Supply is Connected to the Terminal Device 100
“Detecting means identifier C124: remaining battery charge detecting means; detection condition C125: remaining capacity ≦25%”
   Example 3: A Sensor that Measures Distance is Connected to the Terminal Device 100
“Detecting means identifier C124: means of measuring physical distance to the RF (Radio Frequency) tag; detection condition C125: distance to PDA of user A≦50 cm”
   Example 4: A Sensor that Measures Distance is Connected to the Terminal Device 100
“Detecting means identifier C124: means of measuring physical distance to the RF tag; detection condition C125: distance to garage of user A≦2 m”
   Example 5: A Fault Detection Sensor is Built into the Terminal Device 100
“Detecting means identifier C124: fault detecting means; detection condition C125: rate of storage errors of the data storage unit ≧10%”

### Example 6: The CPU Utilization Rate is Monitored by the Terminal Device 100

“Detecting means identifier C124: process monitoring means; CPU utilization rate: ≧90%”

### Example 7: The Terminal Device 100 Detects the State of the Network Connection

“Detecting means identifier C124: audio wave detecting means; detection condition C125: reception of radio waves from a wireless LAN access point is not possible”

### Example 8: The Terminal Device 100 Detects the State of the Network Connection

“Detecting means identifier C124: response time measuring means; detection condition C125: response time for data transfer to a specified device ≧10 ms”

### Example 9: The Terminal Device 100 Detects the State of the Network Connection

“Detecting means identifier C124: traffic detecting means; detection condition C125: traffic percentage increase per unit of time ≧20%”

The communication process rule is defined by combining the above types of events. Furthermore, the determination of whether the communication process rule has been satisfied can be made by determining whether all events that define it have occurred. In addition, it may also be determined that the communication process rule has been satisfied if at least a prescribed percentage of the events has occurred.

### (4-4) Transfer Control Information and Acquisition Control Information

The transfer control information list C103 includes one or more transfer control information C131 entries. Each transfer control information C131 entry includes the following information items (c1)-(c4).
(c1) Process identifier C141: This identifier uniquely specifies a transfer control information C131 entry in the transfer control information list C103.
(c2) Transfer target condition C142: This condition specifies the data that is subject to the transfer process.
(c3) Transfer destination condition C143: This condition specifies the transfer destination of the transfer target data.
(c4) Transfer postprocess C144: This describes the process details for the transfer process target data after the transfer process is complete.

Similarly, the acquisition control information list C104 includes one or more acquisition control information C151 entries. Each acquisition control information C151 entry includes the following information items (d1)-d4).
(d1) Process identifier C161: This identifier uniquely specifies an acquisition control information C151 entry in the acquisition control information list C104.
(d2) Acquisition target condition C162: This condition specifies the data that is subject to the acquisition process.
(d3) Acquisition destination condition C163: This condition specifies the acquisition destination of the acquisition target data.
(d4) Acquisition postprocess C164: This describes the process details for the acquisition process target data after the acquisition process is complete.

### (4-4-1) Transfer Target Condition and Acquisition Target Condition

The transfer target condition C142 will now be explained in greater detail. A condition that specifies the transfer target is, for example, information that is attached or linked in advance to data that is external to, for example, the data processing device/terminal device 100 and the server 200. Examples of such information include “data identifier,” “user identifier,” “data type,” “presence of copyright,” and “data reliability.”

In addition, an example of a description of a separate transfer target condition is information that is attached or linked in the internal processes of the terminal device 100 and the server 200. Examples of such information include a “data transfer and acquisition log” and a “data purchase log.” An acquisition time, an acquisition destination device identifier, an acquisition destination device reliability level, and the like are described in the “data acquisition log.” Specific examples of entries include “data for which an acquisition log exists,” “data acquired from devices with a reliability level of at least 3,” and “data purchased from a content retailer C.”

Furthermore, yet another example of a description of a transfer target condition is one that is based on, for example, the status of the data processing device/terminal device 100 and the server 200. Examples of such include “data held by one's own terminal” and “data that has no data related to one's own terminal.” Data that is not linked to one's own terminal is, for example, data that does not have license information linked to the data content.

An example of a description of a transfer target condition based on a combination of the above is, “data for which an acquisition log exists, and at least one day has elapsed since it was acquired.”

The above explained the transfer target condition C142, but the same applies to the acquisition target condition C162 as well.

### (4-4-2) Transfer Destination Condition and Acquisition Destination Condition

The transfer destination condition C143 describes information that specifies the device that constitutes the transfer destination of the transfer target data. The transfer destination condition may be information that specifies one device or a plurality of devices. Examples of information that specifies one device include the device identifier, the IP address, and the MAC address of the communication unit of the device.

Examples of information that specifies a plurality of devices include a user identifier that specifies a user who owns devices, a network identifier that indicates a network to which devices belong, and a function identifier that indicates a function possessed by devices. Other conceivable transfer destination conditions include, for example, “device that is the shortest network distance away,” “device that is the shortest physical distance away,” and “device determined to complete processing in the shortest time.”

If a plurality of devices is applicable to the transfer destination condition, then the terminal device 100 can perform data transfer to the initially detected device. In addition, if a priority level is set in the transfer destination device, then the data may be transferred to the device that has the highest priority level. When specifying the transfer destination, it is possible to specify the write destination by storage medium type, including the storage medium of one's own terminal. Specifically, the transfer destination may be, for example, an HDD, or an SD (secure digital) card.

The above explained the description of the transfer destination condition C143, but this explanation applies similarly to the description of the acquisition destination condition C163.

### (4-4-3) Transfer Postprocess and Acquisition Postprocess

The transfer postprocess C144 describes the postprocess executed with respect to the transfer target data during the transfer process or after the transfer process is complete.

Examples of descriptions of a postprocess include “delete the transfer completed data,” “invalidate the transfer completed data,” and “lock the transfer completed data.” By executing these postprocesses, it is possible to prevent the simultaneous use of transferred data by a plurality of devices.

In addition, an example of another postprocess is “stop power supply to main functional block of one's own terminal.” By executing this postprocess, it is possible to improve user convenience by automating the operations that he or she must perform.

The above explained the transfer postprocess C144, but this explanation applies similarly to the acquisition postprocess C164.

### [Functions of the Data Processing System]

The following explains the functions of the data processing system S, which executes processing based on control information. The functions of the data processing system S according to the present embodiment can be broadly divided into four categories: (1) a preparatory process of generating and detecting control information, (2) a data transfer process, (3) a data acquisition process, and (4) an electric power source process.

### (1) Preparatory Process of Generating and Detecting Control Information

The preparatory process of generating and detecting control information can be broadly divided into three stages: 1) receive user input, 2) generate and store control information, and 3) prepare for detection. The following sequentially describes each stage in detail.

### (1-1) Receive User Input

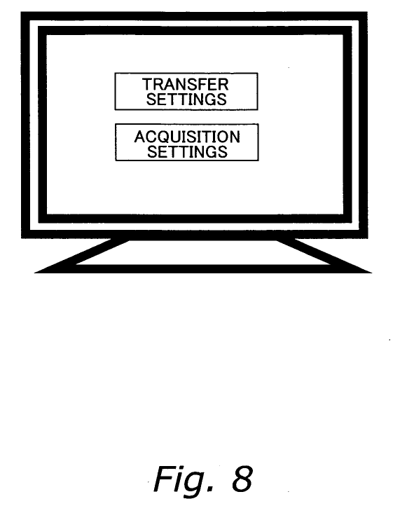

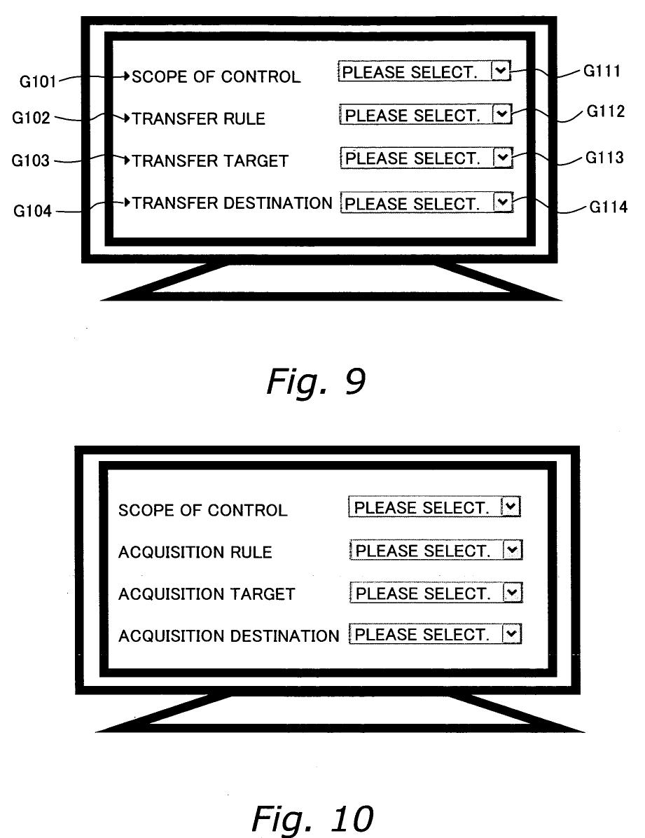

The control information generation unit 300 of the terminal device 100 receives an instruction from the user to set up automatic processing of control information, and displays a screen that receives the input of information needed to generate control information. The generation of control information is preferably performed based on user input. This preference ensures that the automatic movement of data is in line with the user's intention. FIG. 8 through FIG. 10 are examples of control information input screens output by the control information generation unit 300. The menu screen shown in FIG. 8 receives the selection of either “transfer settings” or “acquisition settings.” If “transfer settings” is selected, then the input screen shown in FIG. 9 is displayed. If “acquisition settings” is selected, then the input screen shown in FIG. 10 is displayed. The input screens of FIG. 9 and FIG. 10 are substantially the same, and therefore the following explanation takes the transfer settings input screen shown in FIG. 9 as an example.

The screen shown in FIG. 9 receives the settings for “scope of control,” “transfer rule,” “transfer target,” and “transfer destination” via selections in the pull-down menus. The “scope of control” pull-down menu displays, for example, “all data of the terminal device,” “all data in XX folder,” and “data identifier.” In addition, the supplementary information of the data may display, for example, title and name.

The “transfer rule” item, which corresponds to the communication process rule discussed earlier, describes one or a combination of a plurality of events that define the transfer process. Events, such as “power source is turned off” and “physical distance to another device exceeds stipulated value,” are displayed in the “transfer rule” pull-down menu. If the “physical distance to another device exceeds stipulated value” event is selected, then the control information generation unit 300 receives further input of, for example, information that specifies “another device” and “stipulated value.”

The “transfer target” item describes a condition of the transfer target data, which is the data within the scope of control. The items “all data to be held” and “data for which an acquisition log exists,” for example, are displayed in the “transfer target” pull-down menu. The combination of the set transfer target and control scope specify the transfer target condition in the control information. Furthermore, if part of the data held by the data storage unit 112 is specified as “scope of control,” then control may be performed without receiving the selection of “all data to be held.”

The “transfer destination” item describes the data transfer destination. The server 200, another terminal device in the network, and the like are displayed in the “transfer destination” pull-down menu. The control information generation unit 300 may search for devices with which the terminal device 100 can communicate, and dynamically generate the “transfer destination” pull-down menu by supplementing it. As a method of registering devices in the pull-down menu, a new device may be added to it by, for example, using a card reader to read an RF tag that identifies the device. Furthermore, the control information generation unit 300 may verify whether the terminal device 100 can communicate with the device selected by the user, and if communication is not possible, then the user may be prompted to reset the transfer destination.

FIG. 9 and FIG. 10 do not show the settings of the transfer postprocess and the acquisition postprocess, but it is preferable to provide a screen with fields that receive the settings of these processes, and then to receive the postprocess settings.

FIG. 8 through FIG. 10 explain the case wherein all control information is generated from the start, but it is also possible to simplify the input labor by displaying an input screen, wherein default values have been input by some method, and having the user edit only those portions that need to be changed. It is possible to use as default values, for example, values of control information previously generated, or values set in a prescribed template. Furthermore, since it is possible that the user will omit an input, it is preferable to set the template and default values in advance user by user so that the user can supplement input as needed. In addition, from the perspective of reducing the load on the transfer destination device, it is also possible for the control information generation unit 300 to output a warning if the data count that corresponds to control information C100 entries, wherein the transfer process is set to the same device, exceeds a fixed count. The data count that corresponds to the abovementioned control information C100 entries can be acquired by, for example, searching the control information storage unit 111 and data storage unit 112 of one's own terminal, or by inquiring with another terminal devices 100.

### (1-2) Generation and Storage of Control Information

The control information generation unit 300 generates control information C100 based on input information. The following explanation takes as an example a case wherein control information C100 is generated based on inputs in the transfer settings input screen shown in FIG. 9. The detecting means identifier C124 and the detection condition C125 of the control information C100 are generated based on the settings of the “transfer rule.” The transfer target condition C142 of the control information C100 is generated based on the setting of the “transfer target.” The transfer destination condition C143 of the control information C100 is generated based on the “transfer destination.” If the settings of the transfer postprocess are input, then a transfer postprocess C144 is generated based thereon. If there has been no such input, then the transfer postprocess can be determined based on, for example, the data type of the transfer target data. An example of a setting of the transfer postprocess C144 based on the data type is to set “delete transfer completed data” if the data type is, for example, “copyright exists.”

Next, the control information generation unit 300 stores the generated control information C100. The storage location is determined based on the data type or information input by the user. If the storage location is the control information storage unit 111, then the control information generation unit 300 specifies the data that is linked with the abovementioned control information C100 based on the “scope of control” input settings, and generates a data identifier list that comprises the data identifier of that linked data. Furthermore, the control information generation unit 300 stores the control information C100, as well as the association between the data identifier in the abovementioned data identifier list and the control information C100, in the control information storage unit 111. If the storage location is the data storage unit 112, then the control information generation unit 300 reads the data specified by the abovementioned data identifier from the data storage unit 112. Furthermore, the control information generation unit 300 produces copies of the abovementioned control information C100 in accordance with the number of corresponding data identifiers, and attaches a copy to each of the read data entries. Subsequently, the control information generation unit 300 stores data, to which control information C100 has been attached, in the data storage unit 112.

### (1-3) Detection Preparation

After storing the control information C100, the control information generation unit 300 notifies the detection control unit 102 of the storage location of the control information C100 and of the generation of the control information. Upon receiving that notification, the detection control unit 102 reads the control information C100 from the storage location of which it was notified. The detection control unit 102 extracts the detection control information C111 from the control information C100 and extracts the detecting means identifier C124 included in the detection control information C111. Furthermore, the detection control unit 102 sends the detection condition C125, the control information identifier C101, and the detection control information identifier C121 to the change detection unit 101 that corresponds to the extracted detecting means identifier C124. The change detection unit 101 that receives such stores the received information and prepares to detect the event that matches the stored detection condition C125.

For example, the detection control unit 102 sends the detection condition “power source is turned off,” the control information identifier “CONTROL-INFO-ID-0001,” and the detection control information identifier “DETECT-ID-0001” to the change detection unit “power source state detecting means.” In addition, the detection control unit 102 sends the detection condition “distance to the garage of user A ≦2 m,” the control information identifier “CONTROL-INFO-ID-0001,” and the detection control information identifier “DETECT-ID-0001” to a separate change detection unit “means of measuring physical distance to the RF tag.” In so doing, the “power source state detecting means” and “means of measuring physical distance to the RF tag” change detection units each store the detection condition and stand by for the occurrence of the event that matches such.

### (2) Data Transfer Process

The data transfer process can be largely divided into six stages: 1) event detection, 2) transfer requirement determination, 3) transfer target data acquisition and control information specification, 4) specification of data transfer destination and transfer order, 5) data transfer, and 6) postprocess. The following sequentially discusses each stage in detail. In addition, the process performed at the transfer destination will also be explained.

### (2-1) Event Detection

Any one of the change detection units 101 detects an event that satisfies the stored detection condition C125. Subsequently, that change detection unit 101 sends the stored control information identifier C101 and detection control information identifier C121, along with a detecting means identifier that specifies itself, to the data transfer control unit 104 as a detection notification.

When the data transfer control unit 104 receives this detection notification, it specifies and acquires the control information C100 by keying on the received control information identifier C101. In other words, the data transfer control unit 104 acquires the control information C100 by using the control information identifier C101 as a key to search the control information storage unit 111 and the data storage unit 112. Furthermore, the change detection unit 101 stores the storage location information of the control information C100 and can also send that information to the data transfer control unit 104 when an event is detected.

Furthermore, if two or more detection conditions C125 are included in the detection details list C122 of the detection control information C111, then there is a possibility that a plurality of detection notifications for the identical detection control information C111 will be concentratedly sent to the data transfer control unit 104 in a short time period. To prevent this, the data transfer control unit 104 holds and logs the control information identifier C101, the detection control information identifier C121, the detecting means identifier, and the time when the transfer requirement determination was performed, and if a detection notification is received again within a fixed time interval, then the transfer requirement determination, which is discussed later, may not be performed for that detection notification.

### (2-2) Transfer Requirement Determination

The data transfer control unit 104 specifies the detection control information C111 from the control information C100 by keying on the detection control information identifier C121 included in the detection notification. Furthermore, the data transfer control unit 104 determines whether to perform data transfer based on the detecting means identifier C124 included in the detection details list C122 in the specified detection control information C111, and based on the detecting means identifier included in the abovementioned detection notification. If both identifiers do not match, then it is determined that the transfer process will not be performed. Herein, if the detection details list C122 includes a plurality of detecting means identifiers C124 and detection conditions C125, then the data transfer control unit 104 can determine whether there is a need to perform the transfer process based on whether all detection conditions have been satisfied, i.e., based on whether all events that define the transfer rule have occurred.

The determination of the need to perform the transfer process will now be discussed in further detail. The data transfer control unit 104 extracts a pair that comprises the detecting means identifier C124 and the detection condition C125 from the detection details list C122 in the specified detection control information C111, and then sends that pair to the detection control unit 102. When the detection control unit 102 receives such, it specifies the change detection unit 101 by keying on the detecting means identifier C124. Furthermore, the detection control unit 102 determines whether the detection condition C125 for the specified change detection unit 101 has been satisfied, and then sends the determination result to the data transfer control unit 104. Based on the determination result of one or more change detection units 101, the data transfer control unit 104 determines which of the events that define the transfer rule has occurred.

For example, let us assume that a notification of “power source is turned off” has been sent from the change detection unit “power source state detecting means” to the data transfer control unit 104. The data transfer control unit 104 searches the control information C100 and notifies the detection control unit 102 of one more detection rule “detecting means identifier C124: means of measuring physical distance to the RF tag; detection condition C125: distance to garage of user A ≦2 m” that defines the transfer rule. The detection control unit 102 specifies the change detection unit “means of measuring physical distance to the RF tag” by keying on the detecting means identifier, verifies whether the condition “distance to garage of user A ≦2 m” has been satisfied for the “means of measuring physical distance to the RF tag,” and passes the verification result to the data transfer control unit 104. The data transfer control unit 104 determines whether there is a need to perform the data transfer process based on the verification result.

Furthermore, the data transfer control unit 104 passively waits for a detection notification from each change detection unit 101, and if the occurrence of all events that define the transfer rule has been verified, then the data transfer control unit 104 can perform subsequent processing.

Furthermore, at this point, if the detection details list C122 includes a plurality of detecting means identifiers C124 and detection conditions C125, then it is assumed that interpretation is made by the logical ANDing of all detection conditions, but the transfer rule may be interpreted based on the abovementioned logical operator information, including that which specifies a logical operator relationship of a plurality of detection conditions C125 in the detection details list C122.

### (2-3) Transfer Target Data Acquisition and Control Information Specification

Next, the data transfer control unit 104 keys on the process identifier C123 included in the detection control information C111 and acquires the corresponding transfer control information C131. Furthermore, the data transfer control unit 104 acquires the transfer target condition C142 based on the abovementioned transfer control information C131, and specifies the data that satisfies the transfer target condition C142. Furthermore, if the specified data is in use, then the data transfer may be suspended, or the usage of the data may be forcibly terminated and the transfer process may be subsequently performed. In addition, if the data to be transferred does not exist in the terminal device 100, then data transfer is suspended.

The data transfer control unit 104 references the control information storage unit 111 and the data storage unit 112 to verify whether other control information C100 is linked to the specified data. This is because there are cases wherein control information C100 that is linked to all data held by the terminal device 100 and control information C100 that is linked to each data entry both exist for a given data entry. In this case, the data transfer control unit 104 determines whether any of the control information C100 entries is to be followed. For example, the control information C100 to be followed may be the entry that has the earliest or latest generation time. In addition, a priority level may be set for each control information C100 entry at the time of its generation, and the control information C100 entry with the highest priority level may be set as the one to be followed. Furthermore, the control information C100 to be followed can also be specified based on its details. For example, it is possible to follow the control information C100 entry that has the greatest or the fewest number of detection control information C111 entries. Furthermore, it is also possible to set the control information C100 that is currently being processed as the control information C100 to be followed.

If the control information C100 to be followed is not the control information C100 that is undergoing processing, then the data transfer control unit 104 suspends the process of transferring the target data. In this case, the transfer process is suspended because it is unclear whether the transfer rule has been satisfied for separate control information C100. Further, the transfer process is suspended because if the transfer rule of separate control information C100 has been satisfied, then a detection notification is sent from the corresponding change detection unit 101 to the data transfer control unit 104. The data transfer control unit 104 verifies the control information C100 to be followed for each data entry that is specified as a transfer target, and the transfer process is continued only for data for which it is determined that the control information C100 that is undergoing processing is the one to be followed.

### (2-4) Specification of Data Transfer Destination and Transfer Order

Next, the data transfer control unit 104 acquires the transfer destination condition C143 from the transfer control information C131 and specifies the transfer destination of the data to be transferred. Subsequently, the data transfer control unit 104 passes, for example, the data identifier of the transfer target data and the device identifier, which uniquely identifies the transfer destination device, to the data transfer unit 103. If there is a plurality of data entries to be transferred, then, for each data entry, the data identifier, device identifier and the like are passed to the data transfer unit 103. The above process is performed repetitively in accordance with the number of data entries. Furthermore, if there is a plurality of transfer target data entries and transfer destinations, then all data may be transferred to any one of the transfer destinations, or the burden on that transfer destination may be reduced by sending the data entries to a plurality of transfer destinations in a distributed manner.

The following explains the transfer order for the case of transferring a plurality of data entries. Let us assume a case wherein, according to a detection condition, the communication function of a device becomes unavailable for a short time period after the occurrence of an event. Consider the case wherein, for example, the event is “power source is turned off” or “degradation of radio wave state.” Accordingly, it is preferable to sequence the plurality of data transfers in order to transfer the data efficiently. For example, it is possible to determine the send order in accordance with the quantity of data to be transferred. It is also possible to determine the send order in accordance with, for example, the content of the data to be transferred. Specifically, if the transfer target data are “digital content” and “license information,” then it is preferable to transfer the “license information” first. This is because “digital content” can be easily acquired by, for example, the Internet. Furthermore, for example, a transfer priority level may be set for each data entry, and data entries may be sent in order of descending priority level.

Furthermore, in a case wherein the communication function becomes unavailable before the transfer of all data to be transferred is complete, if the remaining data is transferred when the communication function recovers, then it is effective to perform the transfer by, for example, mobile phone when in a location where the radio wave state is unstable.

### (2-5) Data Transfer

If the data transfer unit 103 acquires a data identifier and a device identifier, then it acquires the data from the data storage unit 112 by keying on the data identifier, and sends the data to the data transfer destination through the communication unit 106.

Furthermore, if the communication unit 106 of the terminal device 100 has a plurality of communicating means, such as a wireless LAN and a wired LAN, then any one of the communicating means is selected to transfer the data. In the case of one transfer target data entry, a communicating means is selected from among the plurality of communicating means that connects to, for example, a “network with good quality communication,” a “network with high speed communication,” or a “network that consumes little electric power.” In the case of a plurality of transfer target data entries, the electric storage capacity of the electric storage unit 123, the network status, and the like are taken into consideration in selecting a communicating means that is capable of transferring a large quantity of data by combining a plurality of pathways.

Furthermore, if data cannot be sent to the transfer destination, then it may be transferred to a nearby device in the online environment, or the process may be terminated. In addition, the data may be written to a storage medium that is held by one's own terminal device 100. In this case, if the transfer target data and the transfer destination device identifier are written to a storage medium in advance, then it is possible to continue the transfer process by connecting the storage medium to a device in the online environment. In addition, if data cannot be transferred to the transfer destination, then it may be transferred to a prespecified device.

### (2-6) Postprocess

If the communication unit 106 of the terminal device 100 receives a termination notification to the effect that data was received from the server 200, then the data transfer unit 103 is notified of such. The data transfer unit 103 acquires the transfer postprocess C144 from the transfer control information C131 and determines whether it is necessary to perform the postprocess on the transferred data. If it is necessary to perform the postprocess, then the data transfer unit 103 performs the process set in the transfer postprocess C144. For example, if the transfer postprocess C144 is set to “delete the transfer completed data,” then the transfer completed data is deleted from the data storage unit 112. In addition, if, for example, the transfer postprocess C144 is set to “lock the transfer completed data,” then the transfer completed data is locked in an unavailable state.

Lastly, the data transfer unit 103 stores the data identifier of the data that completed the transfer, the transfer destination identifier, and the transfer time in the transfer log storage unit 113.

### (2-7) Reception Side Processing

The server 200 receives data via the communication unit 204. The data reception unit 203 stores the received data in the data storage unit 211. When the data storage process is complete, the server 200 sends a normal termination notification via the communication unit 204 to the terminal device 100 that is the send source. Every time the storage of received data in the data storage unit 211 is complete, the server 200 may send a normal termination notification, which includes the data identifier of each data entry, to the terminal device 100. The terminal device 100 that receives such can successively execute postprocesses on the data that corresponds to the data identifier that is included in the normal termination notification.

### (3) Data Acquisition Process

The data acquisition process can be broadly divided into six stages: 1) event detection, 2) acquisition requirement determination and control information specification, 3) acquisition target data specification, 4) specification of data acquisition destination and acquisition order, 5) data acquisition, and 6) postprocess. The following sequentially discusses each stage in detail. In addition, the process performed at the acquisition destination will also be explained. Among the processes below, those processes that are similar to the data transfer process can be similarly performed.

### (3-1) Event Detection

If the change detection unit 101 detects an event that satisfies the stored detection condition C125, then it sends the control information identifier C101, the detection control information identifier C121, and the detecting means identifier that specifies itself to the data acquisition control unit 122 as a detection notification.

### (3-2) Control Information Specification and Acquisition Requirement Determination

If the data acquisition control unit 122 receives a detection notification, then it searches for and acquires the control information C100 by keying on the control information identifier C101. Subsequently, the data acquisition control unit 122 specifies the detection control information C111 from the control information C100 by keying on the detection control information identifier C121 in the detection notification. Furthermore, the data acquisition control unit 122 compares the detecting means identifier C124 of the detection control information C111 and the detecting means identifier in the detection notification, and interrupts the acquisition process if they do not match.

### (3-3) Acquisition Target Data Specification

Next, by keying on the process identifier C123 included in the detection control information C111, the data acquisition control unit 122 searches for and acquires the corresponding acquisition control information C151 from the acquisition control information list C104. The data acquisition control unit 122 extracts the acquisition target condition C162 from the acquired acquisition control information C151 and specifies the data that satisfies the acquisition target condition C162.

Let us consider a case wherein, for example, “data that the terminal device 100 has transferred to another device within one hour” is described as the acquisition target condition C162. In this case, the data acquisition control unit 122 specifies the data identifier (of the data entries linked to the control information C100) for which the transfer date and time in the transfer log storage unit 113 satisfies the acquisition target condition, and the transfer destination device identifier linked to that data identifier.

### (3-4) Data Acquisition

Subsequently, the data acquisition control unit 122 passes the acquisition target data identifier and the device identifier to the data acquisition unit 121. The data acquisition unit 121 sends an acquisition request, which includes the abovementioned data identifier, to the acquisition destination specified by the device identifier. The data acquisition unit 121 stands by for a transfer message that corresponds to the acquisition request, and extracts the data and the data identifier upon receiving that message. Furthermore, the data acquisition unit 121 associates and stores the data identifier and the data in the data storage unit 112.

### (3-5) Postprocess

In the data acquisition process as well, the postprocess may be performed after the data acquisition, the same as in the data transfer process. For example, the playback of the acquired data may be started.

### (3-6) Process of the Acquisition Destination

The processes performed in the terminal device 100 or the server 200 that receives the abovementioned acquisition request will now be explained. Take as an example a case wherein the server 200 has received an acquisition request. The server 200 receives the data acquisition request via the communication unit 204. The data request reception unit 203 extracts the data identifier from the received information and passes such to the data transfer unit 202. The data transfer unit 202 searches the data storage unit 211 by keying on the passed data identifier, and reads the data to be transferred. The data transfer unit 202 sends the read data to the request source terminal device 100 via the communication unit 106.

Furthermore, in the server 200 data transfer process as well, the postprocess can be performed after transfer in accordance with the control information attached to the data or the control information held by the server 200.

Furthermore, if the terminal device 100 is to process the acquisition request, then it is provided with a functional constitution that is similar to the server 200.

### (4) Electric Power Source Process

The electric power source process function preferably is one for which a terminal device 100 is provided that is capable of detecting or predicting the cutoff of electric power supply. The electric power source process calculates the amount of electricity needed to be stored in order to perform the communication process when the power supply has been cut off, and stores that needed amount of electricity in the electric storage unit 123.

The electric storage amount calculation unit 124 reads the control information C100 from the control information storage unit 111 or the data storage unit 112. Next, the electric storage amount calculation unit 124 extracts the detection control information C111 related to the cutoff of the electric power supply. Namely, it extracts the detection control information C111 wherein the detecting means identifier C124 and the detection condition C125 are related to the cutoff of the electric power supply. Next, based on the process identifier C123 of the extracted detection control information C111, the electric storage amount calculation unit 124 specifies the corresponding transfer control information C131 or acquisition control information C151. The electric storage amount calculation unit 124 calculates the amount of electric power required for the transfer process or the acquisition process, based on the specified transfer control information C131 or acquisition control information C151. For example, the electric storage amount calculation unit 124 calculates an electric power value based on, for example, the number of data entries to be transferred, the communicating means to be used, and the electric power consumed by the writing means when writing the data to the recording medium.

The electric storage amount calculation unit 124 calculates an electric power consumption value for each electric power supply-related entry in the control information C100 held by the terminal device 100. The maximum value among the calculated values is sent to the electric storage unit 123. The electric storage unit 123 stores electricity in accordance with the sent value.

In the electric power source process, the terminal device 100 stores the required electric power in the electric storage unit 123, and it is therefore possible to reliably complete the data transfer process, even if the electric power supply is cut off.

### [Process Flow]

The following explains the flow of each process executed by the data processing system S of the present invention, referencing the drawings.

### (1) Preparatory Process of Generation and Detection of Control Information

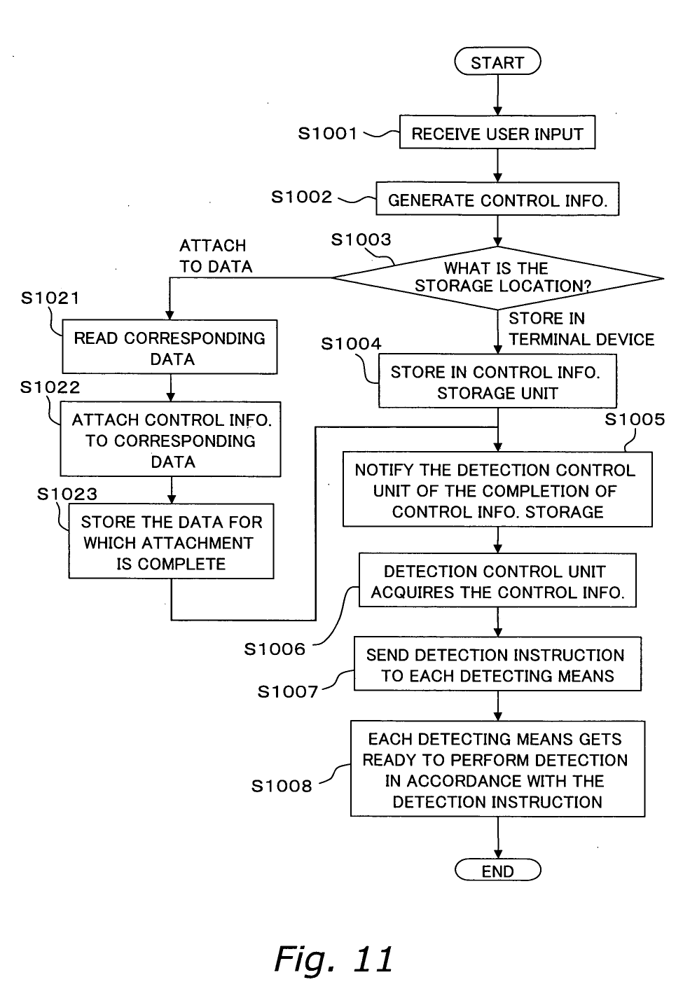

FIG. 11 is a flow chart that shows one example of the flow of the preparatory process of generation and detection of control information executed by the terminal device 100. This example explains a case wherein the control information is generated based on user input. In this process, control information is generated based on user input, and, further, the terminal device 100 transitions to a state wherein it is possible to detect a prescribed event based on the generated control information.

Step S1001: The control information generation unit 300 receives a control information generation instruction, displays a list of information, which is needed to generate the control information, to the user, and then receives the user input.

Step S1002: The control information generation unit 300 generates control information C100 based on the input information.

Step S1003: Based on information input by the user or on the data type, the control information generation unit 300 determines whether to link and store the control information C100 in the terminal device 100, or to link and attach the control information C100 to the data.

Step S1004: If the control information C100 is linked and stored in the terminal device 100, then the control information generation unit 300 stores the control information C100 and its association with the data identifier in the control information storage unit 111.
Step S1005: After storing the control information C100, the control information generation unit 300 notifies the detection control unit 102 of the storage location of the control information C100 along with the generation of the control information.

Step S1006: If the detection control unit 102 receives this notification, then it reads the control information C100 from the storage location of which it was notified.

Step S1007: The detection control unit 102 sends the detection condition C125, the control information identifier C101, and the detection control information identifier C121 to the change detection unit 101 that corresponds to the extracted detecting means identifier C124. Namely, the event to be detected and the location, at which the process detail to be executed if that event occurs is described, are stored in the change detection unit 101.

Step S1008: The change detection unit 101 stores the detection condition C125, the control information identifier C101, and the detection control information identifier C121, and prepares to detect the event that matches the stored detection condition C125.

Step S1021: If it is determined in the abovementioned step S1003 that the control information C100 is to be stored in the data storage unit 112, then the process transitions to step S1021. If the control information C100 is to be attached to data, then the control information generation unit 300 reads the data specified by the abovementioned data identifier from the data storage unit 112.

Step S1022: The control information generation unit 300 produces copies of the control information C100 in accordance with the number of corresponding data identifiers, and attaches a copy of the control information C100 to each read data entry.

Step S1023: The control information generation unit 300 stores the data, to which control information has been attached, in the data storage unit 112.

The steps above execute the generation and storage of control information, along with the preparation for event detection. By performing this process based on user input, it is possible to automatically perform a communication process that is in line with the user's intention.

### (2) Data Transfer Process

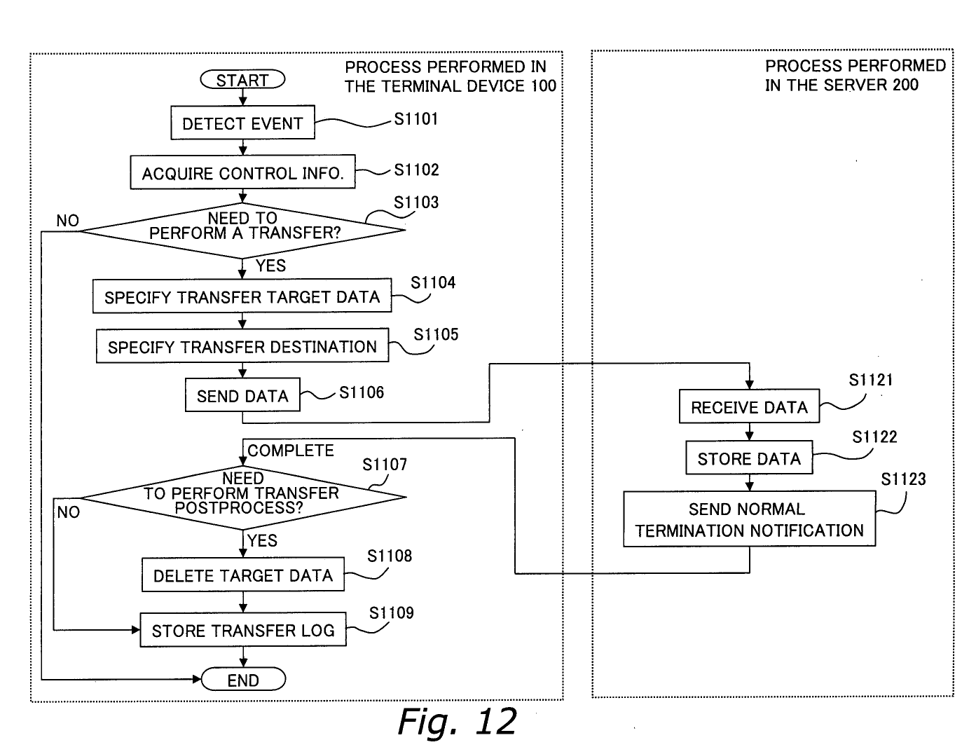

FIG. 12 is a flow chart that shows one example of the flow of the data transfer process executed by the data processing system S. The terminal device 100 performs this communication process based on the control information C100. The explanation herein takes as an example a case wherein data is transferred from the terminal device 100 to the server 200.

### (2-1) Terminal Device Process

Step S1101: If any change detection unit 101 detects an event that satisfies a stored detection condition C125, then the change detection unit 101 sends a detection notification to the data transfer control unit 104.

Step S1102: The data transfer control unit 104 searches the control information storage unit 111 and the data storage unit 112 by keying on the control information identifier C101 included in the detection notification, and acquires control information C100.

Step S1103: The data transfer control unit 104 determines whether there is a need to perform the data transfer process.

Step S1104: By keying on the process identifier C123 included in the detection control information C111, the data transfer control unit 104 acquires the corresponding transfer control information C131. Furthermore, the data transfer control unit 104 acquires the transfer target condition C142 based on the abovementioned transfer control information C131, and specifies the data that satisfies the transfer target condition C142.

Step S1105: The data transfer control unit 104 acquires the transfer destination condition C143 from the transfer control information C131, and specifies the transfer destination of the data to be transferred.

Step S1106: The data transfer control unit 104 transfers the data to the transfer destination. If there is a plurality of data entries, then a transfer order may be determined and the data entries may be transferred accordingly. In addition, if it is possible to select a plurality of communicating means, then any one of the communicating means is selected while considering, for example, communication quality, communication speed, electric power consumption, the amount of electricity stored in the electric storage unit 123, and network status. Furthermore, if a data transfer error occurs due to, for example, a failure of the transfer destination terminal, then the process returns to step S1105 and repeats.

Step S1107: If the data transfer unit 103 receives a normal termination notification from the transfer destination within a fixed time period, then it determines whether there is a need to perform the post process. If a normal termination notification is not received within the fixed time period, then the process terminates. If the normal termination notification is received, then the data transfer unit 103 acquires the transfer postprocess C144 from the transfer control information C131 and determines whether there is a need to perform the postprocess on the transferred data.

Step S1108: If the postprocess needs to be performed, then the data transfer unit 103 performs the process set in the transfer postprocess C144.

Step S1109: Lastly, the data transfer unit 103 transfers the data identifier of the transfer completed data, the transfer destination identifier, and the transfer time to the transfer log storage unit 113.

### (2-2) Server Process

The server 200 that receives data from the terminal device 100 performs the following process.

Step S1121: The server 200 receives data via the communication unit 204.

Step S1122: The data reception unit 203 stores the received data in the data storage unit 211.

Step S1123: The server 200 sends a normal termination notification via the communication unit 204 to the send source terminal device 100.

Based on the above processes, data that the user intends to transfer is transferred between devices in accordance with control information in line with the user's intention. If the cutoff of the electric power supply is set in advance as the transfer rule, then data is automatically transferred to another device upon a cutoff of the electric power supply, and it is therefore possible to prevent the occurrence of a situation wherein data that the user wants to use is located on a device that cannot be externally accessed.

Furthermore, if data cannot be sent to the transfer destination, then it may be transferred to a nearby device in the online environment, or the process may be terminated. In addition, the data may be written to a storage medium held by one's own terminal device 100. In this case, if the transfer target data and the transfer destination device identifier are written to a recording medium, then it is also possible to continue the transfer process by connecting the storage medium to a device in the online environment.

In addition, the above explanation took as an example a case wherein the transfer process was started after verifying that all detection conditions were satisfied, but the transfer process may be started if any one of the detection conditions is satisfied. Specifically, if the first detection condition is detected, then step S1103 is skipped, the processing in step S1104 and step S1106 is performed, and the transfer target data and the transfer destination are specified. Next, the data is transferred to the transfer destination device in a state wherein the transfer target data is locked. The terminal device 100 checks the other detection conditions in parallel with the abovementioned transfer process, and, if it verifies that all detection conditions have been satisfied, then it sends an unlock instruction to the transfer destination device. This method first transfers the transfer target data to the transfer destination, and lastly sends unlock instruction, which makes it possible to reduce the time needed to complete the process.

Furthermore, if it is desired to cancel the state wherein the transferred data is locked, then the target data can also be unlocked by sending a data disable instruction from the transfer source device to the transfer destination device, and then receiving a disabled completion notification therefrom. It is also possible not to send and receive the data itself and to eliminate the data transfer process.

### (3) Data Acquisition Process

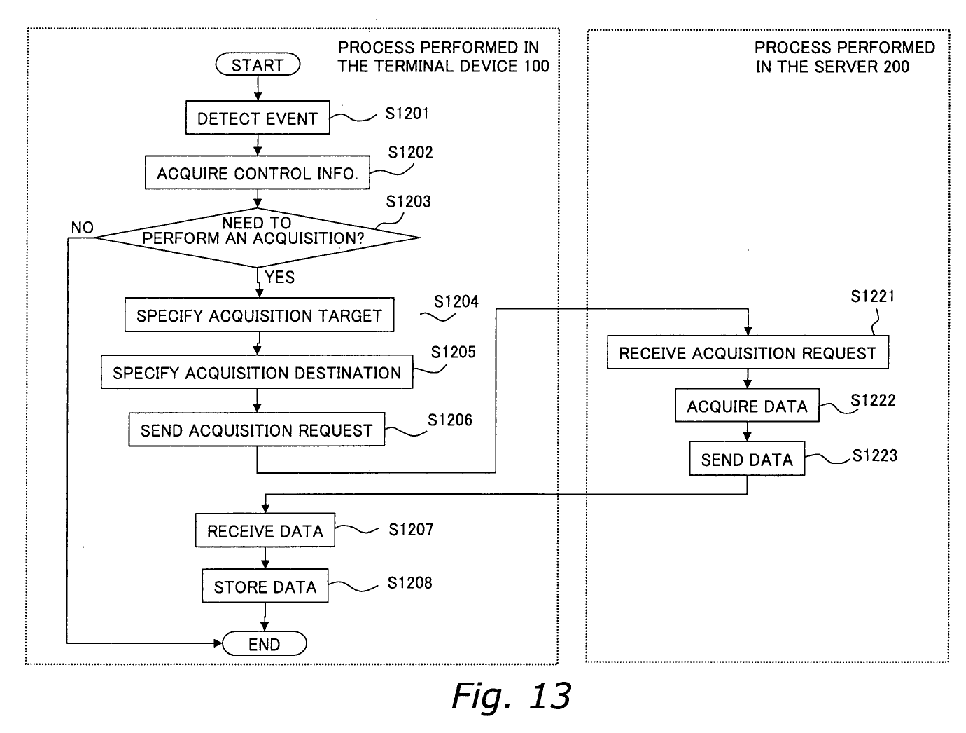

FIG. 13 is a flow chart that shows one example of the flow of the data acquisition process executed by the data processing system S. The terminal device 100 performs this communication process based on the control information C100. The following explanation takes as an example a case wherein the terminal device 100 acquires data from the server 200.

### (3-1) Terminal Device Process

Step S1201: If any change detection unit 101 detects an event that satisfies the stored detection condition C125, then a detection notification is sent to the data acquisition control unit 122.

Step S1202: The data acquisition control unit 122 searches the control information storage unit 111 and the data storage unit 112 by keying on the control information identifier C101 included in the detection notification, and acquires the control information C100.

Step S1203: The data acquisition control unit 122 determines whether there is a need to perform the data acquisition process.

Step S1204: The data acquisition control unit 122 keys on the process identifier C123 included in the detection control information C111 and acquires the corresponding acquisition control information C151. Furthermore, the data acquisition control unit 122 acquires the acquisition target condition C162 based on the abovementioned acquisition control information C151, and specifies the data that satisfies the acquisition target condition C162.

Step S1205: The data acquisition control unit 122 acquires the acquisition destination condition C163 from the acquisition control information C151, and specifies the acquisition destination of the data to be acquired.

Step S1206: The data acquisition control unit 122 sends a data acquisition request to the acquisition destination and stands by to receive data.

Step S1207: The data acquisition unit 121 receives data from the acquisition destination.

Step S1208: The data acquisition unit 121 associates and stores the data identifier and the data in the data storage unit 112.

### (3-2) Server Process

The terminal device 100 or the server 200 that receives the data acquisition request performs the process below. The explanation herein takes as an example a case wherein the server 200 receives an acquisition request.

Step S1221: The server 200 receives a data acquisition request via the communication unit 204.

Step S1222: The data request reception unit 203 extracts the data identifier from the received information, and passes such to the data transfer unit 202. The data transfer unit 202 searches the data storage unit 211 by keying on the passed data identifier, and reads the data to be transferred.

Step S1223: The data transfer unit 202 sends the read data to the request source terminal device 100.

Based on the above process, data that the user intends to move is moved between devices in accordance with control information in line with the user's intention. If the turning on of the power supply is set in advance as the acquisition rule associated with the data, then data is automatically acquired from another device when the power supply is turned on, and therefore data is automatically collected in the device that the user is about to use, which improves user convenience.

In the present embodiment, the function of the terminal device 100 and of the server 200 were explained separately, but the terminal device 100 and the server 200 may each be equipped with both of those functions.

### Second Embodiment

### (1) Domain

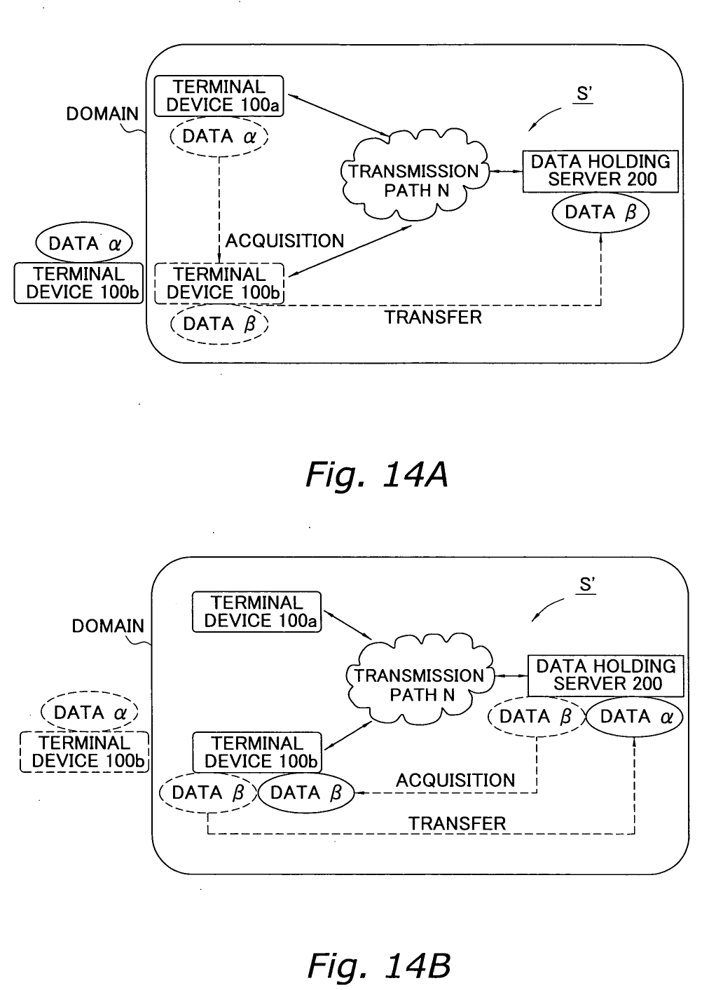

FIG. 14 shows a data processing system S′ according to a second embodiment. A domain D is formed in this data processing system S′. A domain is the grouping of a set of terminals that can share and move data thereamong. Within the domain D, terminal devices 100 and the server 200 can communicate with one another via a wired or wireless transmission path N. In other words, a terminal device 100 that is outside of the domain D is out of the range of communication where it can communicate with other terminal devices 100, the server 200, and the like. If the domain D is formed, then “join or leave the domain D” includes “power source on/off.” Namely, the event “terminal device 100 returns to the domain D” includes not only “terminal device 100 returns from outside to the domain D” but also “power source inside the domain D turns on.” In addition, “terminal device 100 returns to the domain D” may also include “terminal device 100 registers in the domain D.” Similarly, the event “terminal device 100 leaves the domain D” includes not only “leave the inside of the domain D and go outside of the domain D,” but also “power source inside the domain D turns off” and “terminal device 100 withdraws from domain D.”

In addition, in the second embodiment, if the communication process rule is satisfied, it is conceivable not only to perform either the transfer process or the acquisition process, but also to perform both processes. For example, FIG. 14(a) shows a state wherein the terminal device 100b has left the domain D. The broken line indicates the state before leaving the domain D. Before leaving, data α is held by the terminal device 100a. In addition, data β is held by the terminal device 100b itself. The departure of the terminal device 100b causes it to acquire the data a from the terminal device 100a and to transfer the data β to the server 200.

FIG. 14(b) shows a state wherein the terminal device 100b has returned to the domain D. The broken line shows the state before returning. Before returning, the data α is held by the terminal device 100b. By returning, the terminal device 100b transfers the data a to the server 200 and acquires the data β therefrom. This figure shows the terminal device 100b reacquiring the data β, which was transferred to the server 200 when it left the domain D, but it does not necessarily have to reacquire such. In addition, the data a that was acquired when the terminal device 100b left the domain D may be transferred to the acquisition source terminal device 100a without being transferred to the server 200. Thus, by interpreting a departure from the domain D in the broad sense as a turning off of the power supply, it is possible to prevent a situation wherein a terminal device 100 that is about to leave the domain ends up bringing data that is needed within the domain D outside the domain D. In addition, by interpreting a return to the domain D in the broad sense as a turning on of the power supply, it is possible to improve the convenience of the user of the terminal device 100 that returns to the domain D.

### (2) Communication Enabled/Disabled Determination Rule

Furthermore, in the second embodiment, let us assume that the communication process is executed only if the communication process rule and the communication enabled/disabled determination rule are satisfied. The communication enabled/disabled determination rule determines whether to execute the communication process, such as transfer or acquisition. Namely, even if the above communication process rule is satisfied, the terminal device 100 controls the execution of the communication process depending on whether the communication enabled/disabled determination rule is satisfied. As a result, even if the communication process rule is satisfied, the data transfer and acquisition processes will not be executed in inappropriate cases, which makes it possible to perform data processing flexibly. Examples of a communication enabled/disabled determination rule include “transfer is enabled only to terminal of user who owns the data” and “taking outside the domain is disabled if the utilization frequency is high.”

It is conceivable that the communication enabled/disabled determination rule is set principally by the following three parties;
(a) Data distribution source: For example, a content distributor, which distributes data, sets the communication enabled/disabled determination rule.
(b) Domain: For example, an administrator of a home network, wherein domains are formed, sets the communication enabled/disabled determination rule.
(c) Individual: For example, the user of each terminal device 100 or the server 200 sets the communication enabled/disabled determination rule.

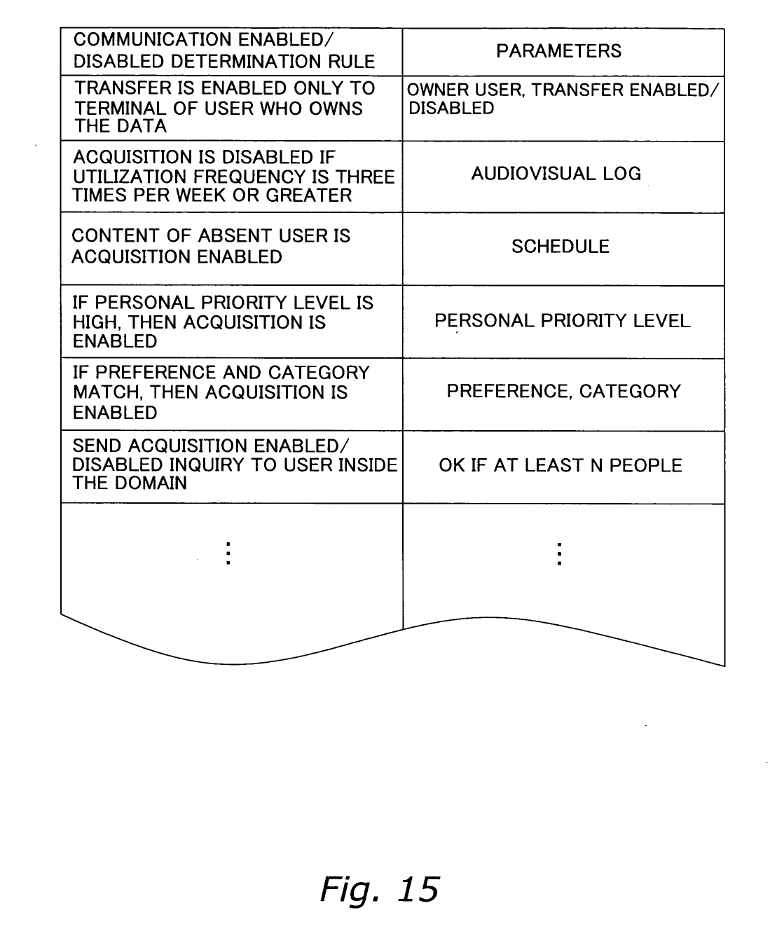

FIG. 15 is an explanatory diagram that shows one example of a communication enabled/disabled determination rule. The communication enabled/disabled determination rule is dependent on parameters. The following explains a communication enabled/disabled determination rule in detail, taking as an example the communication enabled/disabled determination rule in FIG. 15.

### Example 1

The communication enabled/disabled determination rule “transfer is enabled only to the terminal of the owner-user” depends on parameters, such as the “owner-user” of the data and “transfer enabled/disabled.” The communication enabled/disabled determination rule functions, for example, as follows. When the terminal device 100b that has data β tries to leave the domain D, if the data β is transfer enabled and the owner-user of the terminal device 100a is the same as the owner-user of the terminal device 100b, then the terminal device 100b transfers the data β to another terminal device 100a. This communication enabled/disabled determination rule is effective if it is set in order to prevent a situation, for example, in a home environment wherein someone other than an owner arbitrarily takes data outside of the domain D. This rule may be set by, for example, the system administrator in the home or by the owner of each data entry.

### Example 2

The communication enabled/disabled determination rule “acquisition is disabled if utilization frequency is three times per week or greater” depends on parameters, such as the utilization log, e.g., the audiovisual log, of each data entry. More specifically, this rule depends on a parameter “utilization frequency,” which is derived from the audiovisual log. This communication enabled/disabled determination rule functions, for example, as follows. When the terminal device 100b tries to leave the domain D, it acquires the data α, which is located in the terminal device 100a, if the utilization frequency of the data a in the domain D is less than three times per week. This communication enabled/disabled determination rule is effective if it is set in order to prevent a case, for example, in a home, wherein data that is used often by the family is taken out of the domain D. This rule may be set by, for example, the system administrator in the home.

### Example 3

The communication enabled/disabled determination rule, “content of absent user is acquisition enabled” depends on the schedule of each user. This communication enabled/disabled determination rule functions, for example, as follows. If the owner-user of the data α is absent when the terminal device 100b tries to leave the domain D, then the terminal device 100b acquires the data a from the terminal device 100a. This communication enabled/disabled determination rule is effective if it is set, for example, in a home, in order to effectively utilize data that is most often used in a case wherein the owner of that data is absent. This rule may be set in a home, for example, by the system administrator or by the owner of each data entry. Furthermore, if this communication enabled/disabled determination rule is used, and, for example, the schedule of each user is stored in advance in the server 200, then the terminal device 100 can reference the schedules in the server 200 as needed.

### Example 4

The communication enabled/disabled determination rule, “if personal priority level is high, then acquisition is enabled” depends on the setting, “father→mother→child” of the personal priority levels. This communication enabled/disabled determination rule functions, for example, as follows. Let us assume that the terminal device 100b of a child tries to acquire the data a of a father when the terminal device 100b is about to leave the domain D. However, the priority level of the child is lower than that of the father, and therefore he or she cannot acquire the data a of the father. Conversely, it is possible, for example, for the terminal device 100 of the father to acquire the data of the mother or the child when it leaves the domain D. This is because the personal priority level of the father is higher than that of the mother or the child. This communication enabled/disabled determination rule is effective, for example, in a case wherein the father has performed work at home, to prevent the child from taking work related critical data out of the domain D arbitrarily. This communication enabled/disabled determination rule may be set by, for example, the system administrator in the home. Furthermore, if this communication enabled/disabled determination rule is used, and, for example, the personal priority level of the user in the domain D is stored in advance in the server 200, then it is possible for the terminal device 100 to reference the personal priority levels that are set in the server 200 as needed.

### Example 5

The communication enabled/disabled determination rule, “if preference and category match, then acquisition is enabled” depends on preferences and data type, e.g., “soccer,” which comprise the personal information of each user. This communication enabled/disabled determination rule functions, for example, as follows. Let us assume that the terminal device 100b is trying to acquire data a when it is about to leave the domain D. At this time, if the preference of the user of the terminal device 100b and the content of the data a for which an attempt is being made to acquire are both “soccer,” and therefore match, then the terminal device 100b can acquire the data α. This communication enabled/disabled determination rule is effective if, for example, the user wants to enjoy music data, screen data, and the like, which are usually enjoyed in the home, even when going for a drive to a destination that is outside of the domain D. This communication enabled/disabled determination rule may be set by, for example, the system administrator in the home. Furthermore, if this communication enabled/disabled determination rule is used, and the preferences of each user and data types in the domain D are stored in advance in the server 200, then each terminal device 100 can reference such information as needed.

### Example 6

A rule, for example, “send acquisition enabled/disabled [Japanese typo: [symbol] ] inquiry to user inside the domain D” is also conceivable as a communication enabled/disabled determination rule. In this case, “OK if at least N people” is stored as a parameter in the server 200. This communication enabled/disabled determination rule functions as follows. Prior to the acquisition of the data a by the terminal device 100b when leaving the domain D, the data acquisition control unit 122 of the terminal device 100b sends an acquisition enabled/disabled inquiry to a terminal device 100 that is operated by another user. Furthermore, the terminal device 100b waits for a prescribed time for a response to the inquiry; if an “acquisition permitted” response is received from N or more users, then a request to acquire the data α is sent to another terminal device 100a, and the data α is acquired. In addition, the terminal device 100b may output the collected responses. This communication enabled/disabled determination rule is effective for preventing a case wherein, for example, data that is shared in a home is arbitrarily taken out of the domain D by someone. Such a communication enabled/disabled determination rule can be set by the system administrator in the home.

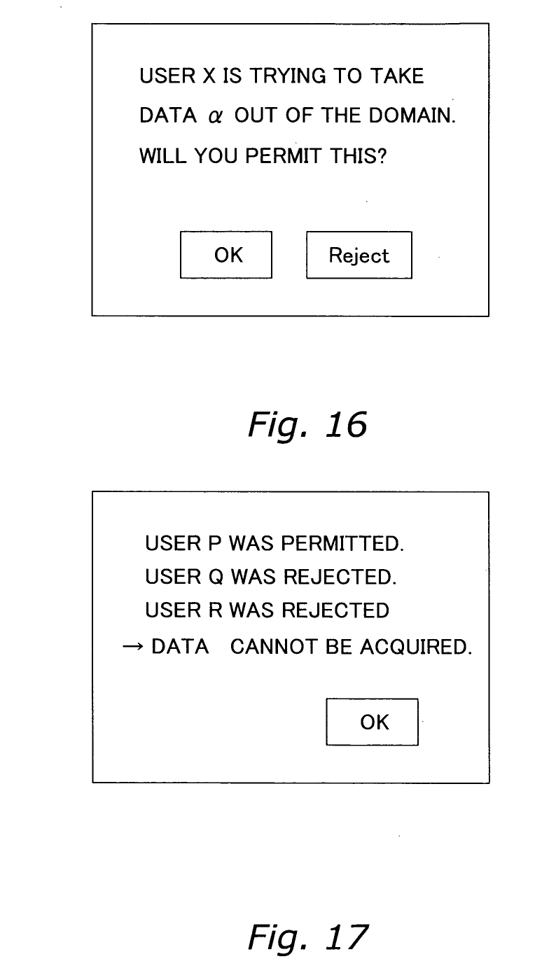

FIG. 16 shows one example of an inquiry screen from a terminal device 100b that is trying to acquire the data α. This screen displays a popup on another terminal device 100 that is online in the domain D. If the “OK” or “Reject” button is pressed in this inquiry screen, then a response is sent from the other terminal device 100 to the inquiry source terminal device 100b. If the same user owns a plurality of terminal devices 100, then the inquiry source terminal device 100b may send an inquiry to all terminal devices 100 of the owner's terminals that are online, and may then determine that a response input by any terminal device 100 is valid. On a different note, the terminal device 100b may send an inquiry to only one of the online terminal devices 100 that are owned by the same user. In this case, if the terminal device 100b sends an inquiry to a terminal device 100 according to its priority level and a response is not returned within a prescribed time, then an inquiry can be sent to the terminal device 100 that has the next priority level. For example, it is conceivable to set the priority level of a mobile phone to be higher than that of a desktop PC. Furthermore, as a separate example, it is also possible for the inquiry source terminal device 100b to send an inquiry to the currently in-use terminal device 100 of the online terminal devices 100 owned by the same user. In this case, the server 200 may manage the state of each terminal device 100 in the domain D, and each terminal device 100 may acquire the state of other terminal devices 100 from the server 200.

FIG. 17 is a screenshot that shows collected responses. This screen is displayed by the terminal device 100b that is trying to acquire the data α. In this example, the screen displays whether the target data can be acquired, as well as who has been given permission and who has been denied permission to take the data a out of the domain D. Thereby, the user of the terminal device 100b can ascertain whether the target data can be acquired. In addition, if the target data cannot be acquired, then the user can ascertain the other user who has denied permission to take the data out of the domain D, and it is therefore possible to take corrective action, such as to appeal to that user that has denied permission.

The communication enabled/disabled determination rules recited herein are of course just examples, and the present invention is not limited thereto.

To make the explanation easier to understand, the present embodiment categorizes the communication enabled/disabled determination rules into transfer enabled/disabled determination rules and acquisition enabled/disabled determination rules. A transfer enabled/disabled determination rule is criteria for determining whether to execute the transfer process. An acquisition enabled/disabled determination rule is criteria for determining whether to execute the acquisition process.

### (3) Control Information

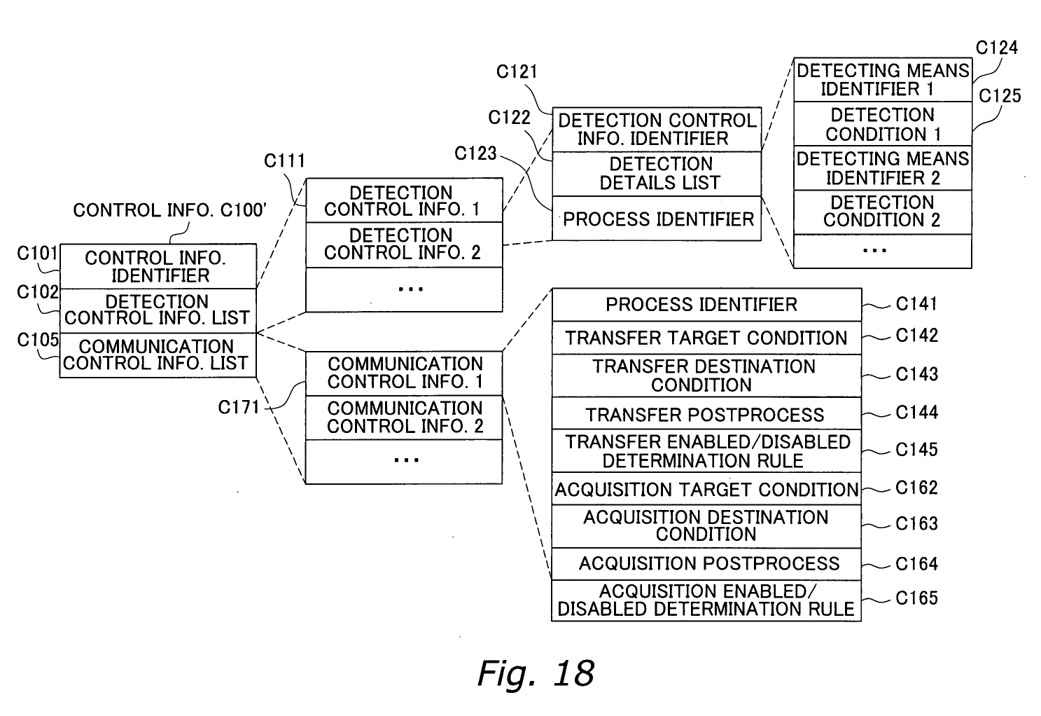

FIG. 18 is a conceptual explanatory diagram of the structure of the control information, which includes the communication enabled/disabled determination rule. Furthermore, in the present embodiment, the functional constitution of the terminal device 100 is the same as that in the abovementioned first embodiment. In addition to the communication process rule, the communication process target condition, and the communication destination condition, the control information also includes the communication enabled/disabled determination rule. The present embodiment assumes two communication processes, the data transfer process and the data acquisition process, and divides the communication enabled/disabled determination rule into the transfer enabled/disabled determination rule and the acquisition enabled/disabled determination rule. The sharing of the communication process rule by the transfer process and the acquisition process is the same as in the first embodiment.

### (3-1) Specific Example of the Entire Structure

Referencing FIG. 18 once again, a specific example of the data structure of control information will now be explained. In the figure, information items that are similar to the embodiments are assigned the same reference symbol as in FIG. 7.

In the present embodiment, control information C100′ has a hierarchical structure. The first level of the control information C100′ includes the following information items (a)-(c).
(a) Control information identifier C101: This identifier uniquely specifies the control information C100′.
(b) Detection control information list C102: This list includes a description of the communication process rule, which is the trigger for executing the communication process. Namely, it describes a condition for starting the communication process with respect to the data linked with the control information C100′. Specifically, it describes a transfer rule or an acquisition rule, which both define one or a combination of two or more events detected by the change detection unit 101 of the terminal device 100.
(c) Communication control information list C105: This list sets the control details of the data transfer process and the data acquisition process. Specifically, the transfer process includes at least a transfer destination condition, and preferably includes a description of the transfer target condition and a transfer postprocess. The acquisition process includes at least the acquisition target condition and the acquisition destination condition, and preferably includes a description of the acquisition postprocess.

### (3-2) Detection Control Information

The detection control information list C102 includes one or more detection control information C111 entries. Each detection control information C111 entry includes the following information items (b1)-(b3).
(b1) Detection control information identifier C121: This identifier uniquely specifies a detection control information C111 entry.
(b2) Detection details list C122: This list describes one or a combination of two or more events that are detectable by the change detection unit 101 of the terminal device 100. The details of the detection details list are the same as those in the first embodiment, and one or the combination of two or more detection conditions C125 included in the detection details list C122, i.e., one or the combination of two or more events, constitutes the trigger to perform the communication enabled/disabled determination.
(b3) Process identifier C123: This identifier describes a pointer to the processing details in the control information C100′ that are executed if the detection details list C122 is satisfied. In the present example, the process identifier C123 describes a pointer to any communication control information C171, which is discussed later.

### (3-3) Communication Control Information

The communication control information list C105 includes one or more communication control information C171 entries. Each communication control information C171 entry includes the following information items (c1)-(c9).
(c1) Process identifier C141: This identifier uniquely specifies a communication control information C171 entry in the communication control information list C105.
(c2) Transfer target condition C142: This condition specifies the data that is subject to the transfer process.
(c3) Transfer destination condition C143: This condition specifies the transfer destination of the transfer target data.
(c4) Transfer postprocess C144: This describes the process details for the transfer process target data after the transfer process is complete.
(c5) Transfer enabled/disabled determination rule C145: This rule describes a condition that determines whether to execute the transfer process.
(c6) Acquisition target condition C162: This condition specifies the data that is subject to the acquisition process.
(c7) Acquisition destination condition C163: This condition specifies the acquisition destination of the acquisition target data.
(c8) Acquisition postprocess C164: This describes the process details for the acquisition process target data after the acquisition process is complete.
(c9) Acquisition enabled/disabled determination rule C165: This rule describes a condition that determines whether to execute the acquisition process.

Of the information mentioned above, the transfer enabled/disabled determination rule C145 and the acquisition enabled/disabled determination rule C165 are as discussed above. The transfer target condition, the transfer destination condition, the transfer postprocess, the acquisition target condition, the acquisition destination condition, and the acquisition postprocess are the same as in the first embodiment.

### (4) Process

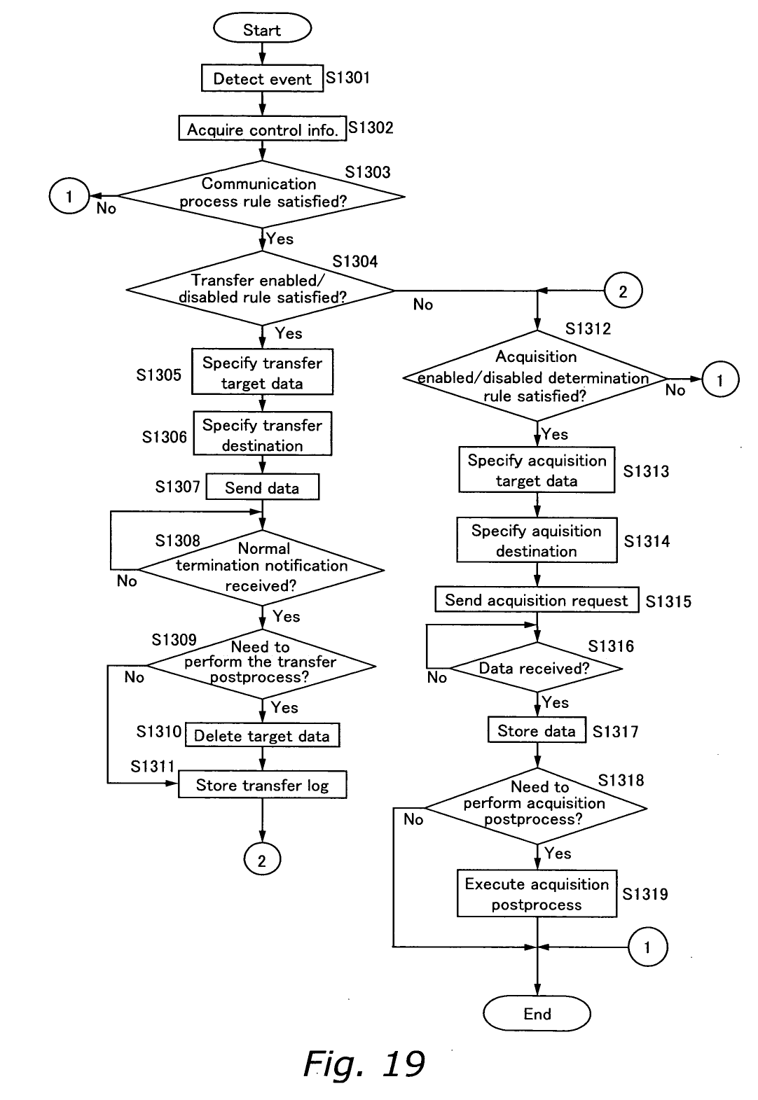

FIG. 19 is a flow chart that shows one example of the flow of the process performed by the terminal device 100 of the present embodiment. With this process, when the prescribed communication process rule is satisfied, the terminal device 100 determines whether to perform the transfer process and/or the acquisition process. Furthermore, based on the above-mentioned determination, the terminal device 100 performs the transfer process, the acquisition process, or both. In the process below, steps S1304-S1311 constitute a process that relates to data transfer; and steps S1312-S1319 constitute a process that relates to data acquisition. The processes performed at the transfer destination and the acquisition destination are the same as those in the first embodiment.

Step S1301: If any change detection unit 101 detects an event that satisfies a stored detection condition C125, then the change detection unit 101 sends a detection notification to the data transfer control unit 104 and the data acquisition control unit 122.

Step S1302: The data transfer control unit 104 and the data acquisition control unit 122 search the control information storage unit 111 and the data storage unit 112 by keying on the control information identifier C101 included in the detection notification, and acquire control information C100′.

Step S1303: The data transfer control unit 104 or the data acquisition control unit 122 determines whether the communication process rule is satisfied. If the rule is not satisfied, then the process terminates. If the rule is satisfied, then the process transitions to step S1304. With the present embodiment, the communication process rule, which triggers the execution of the transfer process and the acquisition process, is shared for both processes, and it is therefore possible for either the data transfer control unit 104 or the data acquisition control unit 122 to perform this determination.

Step S1304: The data transfer control unit 104 determines whether the transfer enabled/disabled determination rule is satisfied. If the rule is satisfied, then the process transitions to step S1305; however, if the rule is not satisfied, then the process transitions to step S1312, which is discussed later.

Step S1305: By keying on the process identifier C123 included in the detection control information C111, the data transfer control unit 104 acquires the corresponding communication control information C171. Furthermore, the data transfer control unit 104 acquires the transfer target condition C142 based on the abovementioned communication control information C171, and specifies the data that satisfies the transfer target condition C142.

Step S1306: The data transfer control unit 104 acquires the transfer destination condition C143 from the communication control information C171, and specifies the transfer destination of the data to be transferred.

Step S1307: The data transfer control unit 104 transfers the data to the transfer destination. If there is a plurality of data entries, then a transfer order may be determined and the data entries may be transferred accordingly. In addition, if it is possible to select a plurality of communicating means, then any one of the communicating means is selected while considering, for example, communication quality, communication speed, electric power consumption, the amount of electricity stored in the electric storage unit 123, and network status. Furthermore, if a data transfer error occurs due to, for example, a failure of the send destination terminal, then the process should return to step S1306 and repeat.

Steps S1308-S1309: If the data transfer unit 103 receives a normal termination notification from the transfer destination, then it determines whether there is a need to perform the post process. If a normal termination notification is not received within the fixed time period, then the process may terminate. If a normal termination notification is received, then the data transfer unit 103 acquires the transfer postprocess C144 from the transfer control information C131 and determines whether there is a need to perform the postprocess on the transferred data.

Step S1310: If the postprocess needs to be performed, then the data transfer unit 103 performs the process set in the transfer postprocess C144. For example, the data transfer unit 103 deletes the transferred data.

Step S1311: The data transfer unit 103 stores the data identifier of the transfer completed data, the transfer destination identifier, and the transfer time in the transfer log storage unit 113.

Step S1312: If the transfer process has already been performed or if the transfer enabled/disabled determination rule is not satisfied, then the data acquisition control unit 122 determines whether the acquisition enabled/disabled determination rule is satisfied. If it is determined that the rule is satisfied, then the process transitions to step S1313; in addition, if it is determined that the rule is not satisfied, then the process terminates. Depending on the acquisition enabled/disabled determination rule, the data acquisition control unit 122 may send acquisition inquiries to other users in the domain D. The data acquisition control unit 122 subsequently collects responses for a fixed time period, and determines whether the acquisition enabled/disabled determination rule is satisfied in accordance with the collected responses. As discussed earlier, the data acquisition control unit 122 may output the collected response results and advance to the next process while waiting for user verification.

Step S1313: The data acquisition control unit 122 keys on the process identifier C123 included in the detection control information C111 and acquires the corresponding communication control information C171. Furthermore, the data acquisition control unit 122 acquires the acquisition target condition C162 based on the abovementioned communication control information C171, and specifies the data that satisfies the acquisition target condition C162.

Step S1314: The data acquisition control unit 122 acquires the acquisition destination condition C163 from the communication control information C171 and specifies the acquisition destination of the data to be acquired.

Step S1315: The data acquisition control unit 122 sends a data acquisition request to the acquisition destination.

Step S1316-S1317: The data acquisition unit 121 stands by to receive the requested data (S1316); if data is received from the acquisition destination, then the acquired data is associated with the data identifier and stored in the data storage unit 112 (S1317). Furthermore, the data acquisition control unit 122 can also monitor whether the data is received within a fixed time period, and if the data is not received, then it can also take action such as resending the data acquisition request or terminating the process.

Step S1318-S1319: The data acquisition control unit 122 determines whether there is a need to perform the postprocess; if it is determined to be “needed” (S1318), then the process set in the acquisition postprocess C164 is executed (S1319). For example, the newly acquired data and its identifier will be associated and written in an acquisition log.

In the process above, the terminal device 100 performs the communication process only in the case wherein it is not simply the communication process rule that is satisfied, but the communication enabled/disabled determination rule is satisfied as well. Performing this process makes it possible to perform a communication process that is suited to the circumstances, and thus improves user convenience. In addition, with the process described above, leaving and returning to the domain D includes turning the power supply on and off, and it is possible to use the data of a terminal device 100 that has left the domain D. A terminal device 100 that is about to leave the domain D not only transfers but also acquires data, which enables the terminal device 100 to use data outside of the domain D. Accordingly, this is advantageous from the user's perspective because the desired data can be used at any time and in any place.

### (5) Other

A mode is also conceivable wherein, when the terminal device 100b sets out to acquire data a that is protected by a copyright and then leave the domain D, the terminal device 100b acquires only the license data of the data a and leaves the content data in the domain D. In this case, it is possible to prevent a situation wherein the terminal device 100b itself can no longer play the data α, but another terminal device 100 in the domain D can. Moreover, when the terminal device 100b returns to the domain D, it need only transfer the license data to a terminal device 100 or the server 200 in the domain D, and does not need to transfer the content data. Accordingly, this is advantageous in that only a small amount of data is transferred when returning to the domain D, and resources therein are therefore not wastefully used.

Furthermore, limiting the data that can be acquired based on, for example, the type, function, and environment of the terminal device 100b that is about to leave the domain D makes it possible to reduce the amount of data moved in the domain D. For example, if the terminal device 100b that is about to leave can acquire the content data of the data a even when it is outside of the domain D, then the terminal device 100b acquires only the license data of the data a when leaving the domain D. Moreover, if the terminal device 100b cannot acquire the content data of the data a outside of the domain D, then the terminal device 100b acquires both the license data and the content data of the data a when leaving the domain D. It is possible to determine as follows whether the terminal device 100b can acquire the content data outside of the domain D. For example, if the communication band of the terminal device 100b itself is below a prescribed value, then it can be determined that the terminal device 100b cannot acquire the content data outside of the domain D. In addition, for example, if the terminal device 100b itself is a mobile phone, a PDA (personal digital assistant) or the like, or if the free storage capacity is below the amount required by the data α, then it can be determined that the terminal device 100b cannot acquire the data α. Furthermore, it is possible to determine whether the data a can be acquired based on, for example, the result of the determination as to whether hardware or software needed to replay the data α is present in the terminal device 100b.

### Third Embodiment

### Functional Constitution

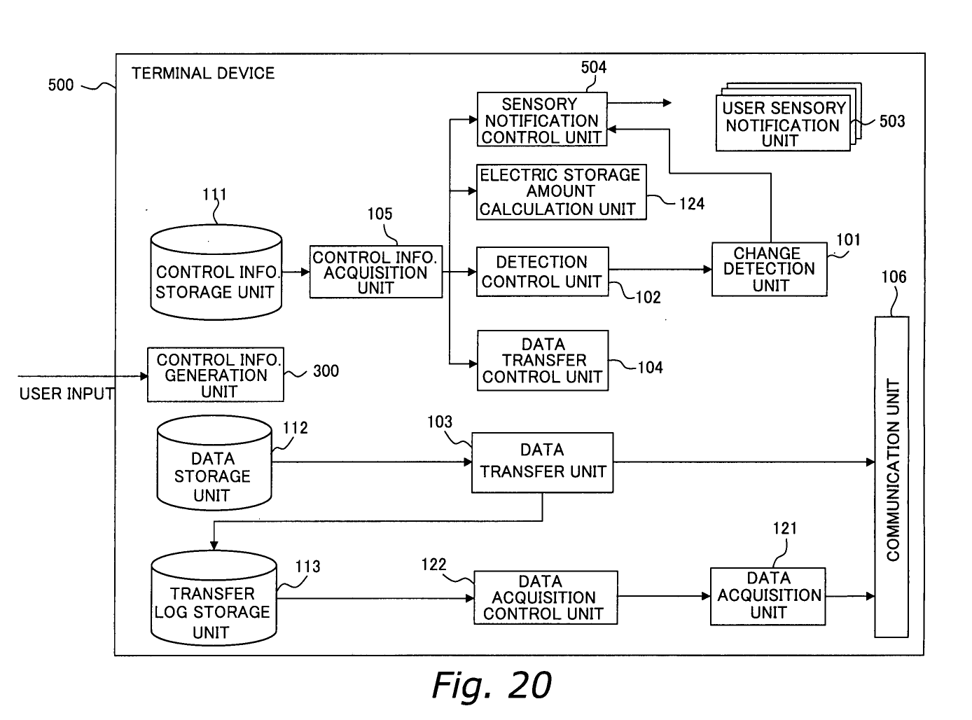

The following explains the details of the third embodiment of the present invention, referencing the drawings. FIG. 20 is a functional block diagram of a terminal device 500 according to the third embodiment. In a data processing system SS of the third embodiment, the terminal device 500 shown in FIG. 20 replaces the terminal device 100 in the data processing system S of the first embodiment. In FIG. 20, elements that are assigned the same symbol in the first embodiment have the same function as that in the first embodiment. In the present embodiment, a user sensory notification unit 503 and a sensory notification control unit 504 are added to the terminal device 100. The user sensory notification unit 503 comprises one or more output devices that notify the user of information specified by the control information. The sensory notification control unit 504 controls the user sensory notification unit 503 based on the control information. In a data processing system SS of this type, control information is generated, based on user input, that is related to a sensory notification process, which provides notifications to the user.

### [Control Information]

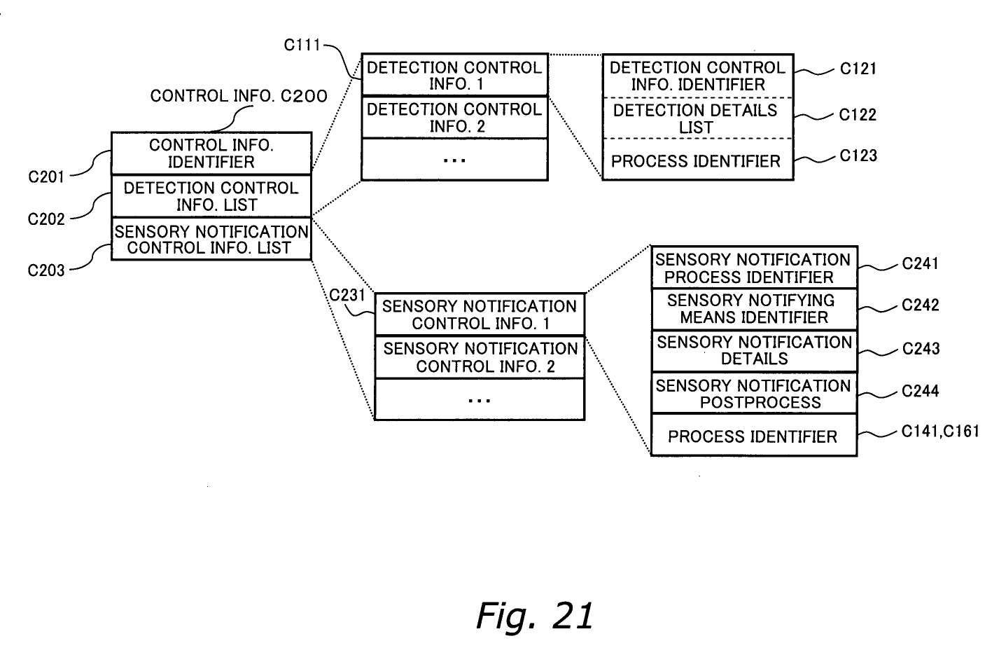

FIG. 21 is a conceptual explanatory diagram that shows the structure of control information C200. In the present embodiment, the process is performed using the control information C200 in addition to the control information C100 discussed in the first embodiment.

The control information C200 includes the following information items (a)-(c).
(a) Control information identifier C201: This identifier uniquely specifies the control information C200.
(b) Detection control information list C202: This list includes a description of the sensory notification process rule, which is the trigger for executing the sensory notification process. It contains information similar to that in the abovementioned detection control information list C102.
(c) Sensory notification control information list C203: This list sets the control details of the user sensory notification process. It includes at least a sensory notifying means specification, sensory notification details, and a transfer process or a process identifier that specifies an acquisition process.

The sensory notification control information list C203 includes a plurality of sensory notification control information C231 entries. Each sensory notification control information C231 entry includes the following information items (c1)-(c5).
(c1) Sensory notification process identifier C241: This identifier uniquely specifies the sensory notification control information C231 in the sensory notification control information list C203.
(c2) Sensory notifying means identifier C242: This identifier specifies the output device that notifies the user of information.
(c3) Sensory notification details C243: These details specify the information of which the user is notified.
(c4) Sensory notification postprocess C244: This process specifies the need to perform a process, and the details of that process, after the sensory notification process is complete.
(c5) Process identifier C141 or C161: These identifiers specify the communication process, such as transfer and acquisition. Thereby, it is possible to associate the communication process and the sensory notification process.

Examples of output devices for notifying the user of information include: an output device that visually notifies the user; an output device that auditorly notifies the user; an output device that tactually notifies the user; and an output device that olfactorily notifies the user. Examples of specific output modes that use these output devices include: displaying information on a display; outputting audio by a speaker, outputting a warning sound; vibrating the terminal device; and generating a warning smell.

Examples of information of which the user is notified include boilerplate information, and information that is acquired according to the circumstances. Examples of boilerplate information include: “warning that data from another device cannot be acquired,” and “sensory notification details number 11,” which specifies the details to be auditorily, tactually, or olfactorily informed. Here, the sensory notification details number identifies, for example, a warning sound, wherein number 1 is a low tone that means that data cannot be externally acquired, and number 2 is a high tone that means that the synchronization of data, such as a schedule, that is held by a plurality of devices is not complete. An example of information that is acquired according to circumstances includes: “list of data held by one's own device.”

Examples of processes that are performed during the sensory notification process or after the completion of the sensory notification process include a process that reinforces the sensory notification of the user, and a process that prompts the user to perform an operation on the data. Examples of processes that reinforce the sensory notification of the user include, “perform sensory notification process at fixed intervals” and “perform sensory notification process with a different sensory notifying means.” An example of a process that prompts the user to perform a process on the data is “display process start button.”

### [Process]

In the flow chart shown in FIG. 11, the processes of generating and storing the abovementioned control information C200 and of preparing for detection are similar to the flow (step S1001, S1002, S1004-S1008) in the case wherein the storage location of the control information C100 is on one's own terminal 100 side.

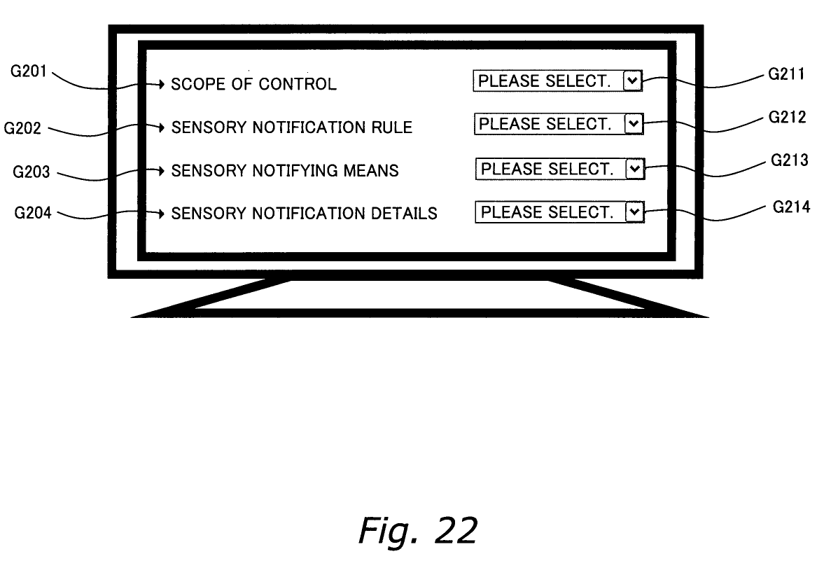

FIG. 22 is a screen shot that receives user input in order to generate the control information C200. Based on the input information received by this screen, the control information C200 is generated and stored in the control information storage unit 111. Each input item can be selected and input from a pull-down menu. For example, “display on the display” and “read the sensory notification details out loud” are displayed in the “sensory notification rule” pull-down menu. Furthermore, “warning that data from another device cannot be acquired,” “list of data held by one's own terminal,” and the like are displayed in the “sensory notification details” pull-down menu.

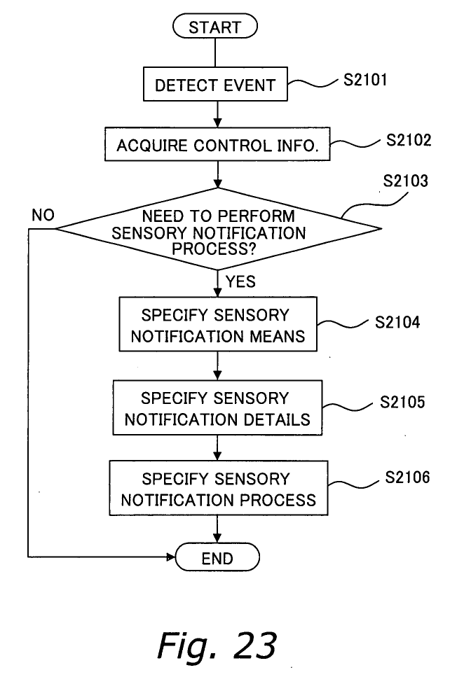

FIG. 23 is a flow chart that depicts the flow of the sensory notification process, which is executed by the terminal device 500.

Step S2101: If a change detecting means of the change detection unit 101 detects an event that satisfies the stored detection condition C125, then the control information identifier C201, the detection control information identifier C121, and its own detecting means identifier are sent to the sensory notification control unit 504 as a detection notification.

Step S2102: If the sensory notification control unit 504 receives a detection notification, it searches for the control information C200 in the control information storage unit 111 by keying on the control information identifier C201 included in the detection notification, and reads the control information C200.

Step S2103: The sensory notification control unit 504 specifies the detection control information C111 from the control information C200 by keying on the detection control information identifier C121. Furthermore, the sensory notification control unit 504 determines whether there is a need to perform the sensory notification process based on whether the detecting means identifier C124 of the detection control information C111 matches the detecting means identifier included in the detection notification. The determining method can be performed similarly to that in the first embodiment. If the sensory notification process is unnecessary, then the present process terminates.

Step S2104: If the sensory notification process continues, then the sensory notification control unit 504 keys on the process identifier C123 included in the specified detection control information C111 and specifies the corresponding sensory notification control information C231. The sensory notification control unit 504 acquires the sensory notifying means identifier C242, the sensory notification details C243, the sensory notification postprocess C244, and the process identifier C141 or C161 from the sensory notification control information C231. Furthermore, the sensory notification control unit 504 specifies the output device based on the sensory notifying means identifier C242 (step S2104), the details of which the user is sensorily notified based on the sensory notification details C243 (step S2105), and the process that is performed after the user has been sensorily notified based on the sensory notification postprocess C244 (step S2106).

Let us assume, for example, that the sensory notifying means identifier C242 is, “display on the display,” the sensory notification details C243 is, “list of data held by one's own device,” and the sensory notification postprocesses C244 are, “warning that data from another device cannot be acquired” and “display process start button.” In this case, the sensory notification control unit 504 acquires, from the data storage unit 112, data that is linked to the control information C200 and a list of the data that is held by the terminal device 500, and displays both a warning and a processing start button on the display.

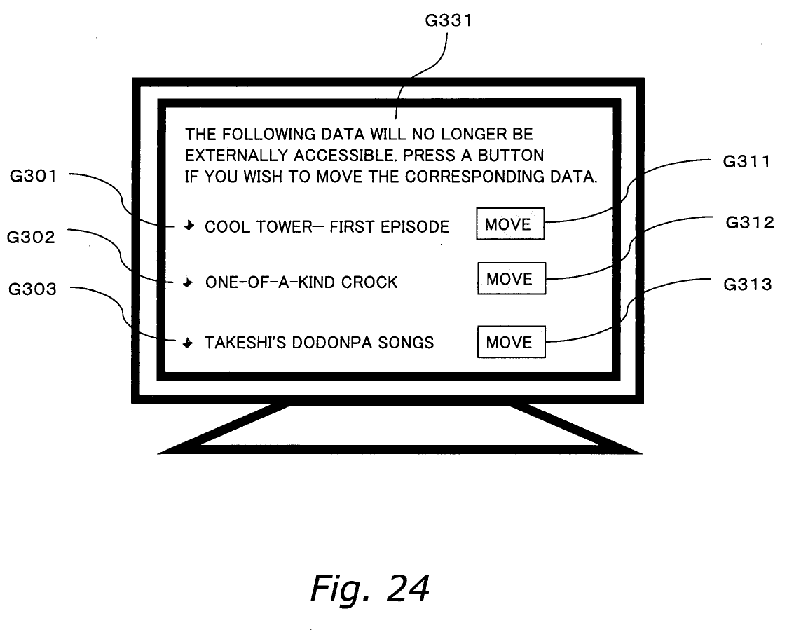

FIG. 24 shows an example of a visual sensory notification output. The user is prompted to perform a data transfer process by the display of data to be processed G301-G303, and data processing start buttons “MOV” G311-G313, which are linked to one another. If the communication process rule set in the control information is satisfied, this screen is displayed. If a button on the screen is pushed, then the transfer destination device can receive user input; in addition, if the user is notified of the transfer destination set in the control information C200 and the user's consent is obtained, then the transfer process can be started.

### Other Embodiments

### (A) Transfer Log

The abovementioned first embodiment explained a case wherein, after a certain terminal device 100a transferred data to a separate terminal device 100b, the terminal device 100a used a transfer log when reacquiring that data. Let us now consider a case wherein, after the terminal device 100a has transferred data to the terminal device 100b and the terminal device 100b has further transferred that data to a separate terminal device 100c, the terminal device 100a uses the transfer log when reacquiring that data. In this case, the following two methods are conceivable.

(1) The terminal device 100c that holds the abovementioned data is specified by tracing the transfer log held by each terminal device. Specifically, the terminal device 100a sends an acquisition request to the terminal device 100b based on the transfer log held by the terminal device 100a itself. The terminal device 100b sends an acquisition request to the terminal device 100c based on the transfer log held by the terminal device 100b itself. Furthermore, the terminal device 100b may notify the terminal device 100a of specified information of the terminal device 100c.

(2) The terminal device 100c that holds the abovementioned data is specified based on information that merges the transfer logs of all terminal devices. Specifically, the transfer logs of all terminal devices are collected in a specified terminal, e.g., the server 200. Furthermore, the transfer logs in the server 200 are merged. The terminal device 100a can specify the terminal device 100c by sending an inquiry to the server 200. If, in the control information, “perform data transfer process” is set as the communication process rule, “transfer log related to data to be transferred” is set as the communication process target, and “server 200” is set as the communication destination, then it is possible to collect the transfer data in the server 200.

Furthermore, it is also possible when transferring data for each terminal device 100 to also send a transfer log related to the transfer data, and to merge the transfer logs at each terminal.

(B) Furthermore, if the change detection unit 101 detects an event in the third embodiment, a detection notification is sent to the data transfer control unit 104 or the data acquisition control unit 122 in the same terminal device. However, the detection notification may be sent to the data transfer control unit 104 or the data acquisition control unit 122 of a different terminal device.

For example, if a sensor attached to a mobile phone detects that it has approached home, then a detection notification is sent from the mobile phone to the server 200. The server 200 acquires music content in accordance with control information, and sends it to the mobile phone. The mobile phone outputs the music content, thus enabling the user of the mobile phone to enjoy BGM.

(C) In the above explanation, the control information generation unit 300 is in the terminal device 100, but a control information generation unit 300 included in another device may generate the control information and attach it via a network.

(D) The method executed by the abovementioned device, the program that executes that method, and a computer readable recording medium whereon that program is recorded are included in the scope of the present invention. Here, examples of the recording medium include a computer readable-writable flexible disk, a hard disk, semiconductor memory, a CD-ROM, a DVD, and a magneto-optic disc (MO).

### Industrial Field of Application

Even after the data processing device of the present invention can no longer be externally accessed, data that was held by that data processing device can be accessed and used by another data processing device. The present invention can also be adapted to a data replay device or a recording device, such as an STB, a digital TV, a DVD recorder, an HDD recorder, a PC, a PDA, and a mobile phone, or a device that is a composite thereof.

1-15. (canceled)

16. A data processing device that communicates data within domains, wherein each domain includes at least one data processing device capable of communicating data,
the data processing device comprising:
an event detecting unit that detects an event regarding joining and leaving any domain;
a control information storing unit that stores control information, the control information including a communication process rule wherein one or a combination of two or more events is prescribed;
a communication process controlling unit that, based on an event detected by the event detecting unit, determines whether the communication process rule in the control information is satisfied; and
a communicating unit that performs the communication process on the data if the communication process controlling unit determines that the communication process rule is satisfied.

17. A data processing device according to claim 16, wherein
the control information storing unit associates and stores the communication process rule with a communication enabled/disabled determination rule, for determining whether or not to execute the communication process;
if it is determined that the communication process rule is satisfied, then the communication process controlling unit further determines whether or not to execute the communication process based on the communication enabled/disabled determination rule; and
if the communication process controlling unit determines that the communication process is to be executed, then the communicating unit performs the communication process on the data.

18. A data processing device according to claim 16, wherein
the communication process is data transfer; and
the data processing device further comprising:
a data storing unit that stores data that is a potential transfer target; wherein,
if the communication process controlling unit determines that the communication process rule is satisfied, then the communicating unit reads the transfer target data from the data storing unit, and transfers the read data to a transfer destination.

19. A data processing device according to claim 16, wherein
the communication process is data acquisition; and
if the communication process controlling unit determines that the communication process rule is satisfied, then the communicating unit acquires the acquisition target data from an acquisition destination that stores that data.

20. A data processing device according to claim 18, wherein
the control information storing unit associates and stores the communication process rule with a communication destination condition, which specifies a communication destination with which the communication process is performed; and
the communicating unit determines the transfer destination or the acquisition source based on the communication process rule associated with the communication destination condition.

21. A data processing device according to claim 18, wherein
the control information storing unit associates and stores the communication process rule with a communication process target condition which specifies data that is subject to the communication process; and
the communicating unit performs the communication process on the data specified by the communication process rule associated with the communication process target condition.

22. A data processing device according to claim 18, wherein
the control information storing unit associates and stores a control information identifier, which identifies the control information, with a data identifier, which identifies data that is subject to the communication process.

23. A data processing device according to claim 18, wherein
the control information storing unit integrally stores the data, which is subject to the communication process, and the control information.

24. A data processing device according to claim 18, wherein
the control information storing unit associates and stores the communication process rule with a postprocess, which is executed after the communication process; and
the communicating unit executes the postprocess after the communication process.

25. A data processing device according to claim 18, wherein
the control information storing unit associates and stores the communication process rule with a notification process rule, which specifies a notification process that notifies a user;
further comprising:
a notification process controlling unit that, based on an event detected by the event detecting unit and the communication process rule in the control information, determines whether or not there is a need to perform the notification process with respect to the user; and
a notification processing unit that, if the notification process controlling unit determines that there is a need to perform the notification process, executes the notification process with respect to the user specified by the notification process rule prior to executing the communication process.

26. A data processing device according to claim 18, further comprising:
a control information receiving unit that receives the registration of control information on a user basis;
wherein,
the control information storing unit stores the control information user by user.

27. A data processing device according to claim 18, further comprising:
a communication process log storing unit that stores a processing log of the communication processes performed by the communicating unit.

28. A data processing device according to claim 18, further comprising:
an electric power storage control unit that calculates the amount of electric power needed to execute the data communication process, and controls the storage of needed electric power.

29. A data processing method that is executed by a data processing device that communicates data within domains,
wherein each domain includes at least one data processing device capable of communicating data,
the data processing method comprising:
an event detecting step that detects an event regarding joining and leaving any domain;
a control information storing step that stores control information that includes a communication process rule, wherein one or a combination of two or more events are prescribed;
a communication process controlling step that, based on an event detected by the event detecting step, determines whether or not the communication process rule in the control information is satisfied; and
a communicating step that performs the communication process with respect to the data if the communication process controlling step determines that the communication process rule is satisfied.

30. A data processing program that is executed by a computer that communicates data within domains,
wherein each domain including at least one computer capable of communicating data and,
wherein the computer is caused to function as:
an event detecting unit that detects an event regarding joining and leaving any domain;
a control information storing unit that stores control information that includes a communication process rule, wherein one or a combination of two or more events is prescribed;
a communication process controlling unit that, based on an event detected by the event detecting unit, determines whether or not the communication process rule in the control information is satisfied; and
a communicating unit that performs the communication process with respect to the data if the communication process controlling unit determines that the communication process rule is satisfied.

31. A data processing device according to claim 17, wherein the communication enabled/disabled determination rule is set by any of a data source, domain or the data processing device.

32. A data processing device according to claim 17, wherein:
the communication enabled/disabled determination rule permits a transfer of the data to an owner of the data;
when the event detecting unit detects the data processing device leaving a domain, the communication process controlling unit determines whether or not data should be transferred based on whether or not an owner of an another data processing device is the owner of the data; and
when the communication process controlling unit determines that the data is to be transmitted, the data is transferred to the another data processing device.

33. A data processing device according to claim 17, further comprising a use history storing unit for storing a use history of the data, wherein:
the communication enabled/disabled determination rule permits a transfer of the data based on whether or not a predetermined use frequency is satisfied;
when the event detecting unit detects the data processing device leaving a domain, the communication process controlling unit determines whether or not the data should be acquired based on a use frequency obtained from a usage history of the data; and
the communication unit acquires the data externally when the communication process controlling unit determines that the data is to be acquired.

34. A data processing device according to claim 17, further comprising a priority level acquiring unit for externally acquiring a personal priority level that is set to each user of the data processing device in the domain, wherein:
the communication enabled/disabled determination rule permits a transfer of the data to a data processing device of a user having a higher priority level than an owner of the data;
when the event detecting unit detects the data processing device leaving a domain, the communication process controlling unit determines whether or not data should be acquired based on the personal priority level acquired externally; and
the communication unit acquires the data externally when the communication process controlling unit determines that data is to be acquired.
